(19) United States
(12) Patent Application Publication
(10) Pub. No.: US 2021/0307480 A1
(43) Pub. Date: Oct. 7, 2021

(54) DEVICE AND SYSTEM FOR GENERATING AND DELIVERING LATHER

(71) Applicant: Moose Design, Inc., Dover, DE (US)

(72) Inventors: Boaz ZUCKER, Tel Aviv (IL); Shlomo ZUCKER, Michmoret (IL)

(73) Assignee: Moose Design, Inc., Dover, DE (US)

(21) Appl. No.: 17/263,210

(22) PCT Filed: Aug. 5, 2019
(86) PCT No.: PCT/IL19/50889

§ 371 Date: Jan. 26, 2021

Related U.S. Application Data
(60) Provisional application No. 62/714,707, filed on Aug. 5, 2018.

(51) Int. Cl. A45D 27/06; B01F 3/04; B01F 7/00; B01F 1/00

(52) U.S. Cl. CPC A45D 27/06; B01F 3/04453; B01F 7/00908; B01F 7/00558; B01F 2215/0031; B01F 7/008; B01F 1/0011; A45D 2200/155; B01F 7/00341

(57) ABSTRACT

The present invention discloses a system for generating lather comprising a device comprising: a capsule compartment configured to receive at least one capsule; said capsule comprising at least one lather-generating raw material; a liquid source configured to provide at least one liquid; a lather mixing cell configured to generate lather from said at least one lather-generating raw material and said at least one liquid; a temperature modulator configured to provide lather at a chosen temperature; a receptacle configured to receive said generated lather; and a capsule comprising at least one lather-generating raw material.

### RELATED APPLICATION/S

This application claims the benefit of priority under 35 USC § 119(e) of U.S. Provisional Patent Application No. 62/714,707 filed 5 Aug. 2018, the contents of which are incorporated herein by reference in their entirety.

### FIELD OF THE INVENTION

The present invention relates to a device and system for generating and dispensing a warm lather and in particular, to such a device and system for producing a warm lather such as shaving cream, from a capsule.

### BACKGROUND OF THE INVENTION

In order to soften and condition facial beards in preparation for shaving by a razor, it is the common practice to first apply a shaving cream or lather to the facial region. The use of lather is preferred by many shavers, for in lather the active ingredients are intermingled with air bubbles to provide greater penetrating action on the beard.

Shaving cream and/or lathers generally used today are provided from aerosol canisters that eject a gel, foam or lather that is applied to the face. Such canisters are provided in different cosmetic forms and fragrances, consistencies, so as to personalize the feel to an individual user. However, current canisters are limited in that the shaving gel and/or lather are provided cold and do not offer hot form of the lather. Furthermore, the canisters as sold as large sizes limiting the user's options for changing the type of shaving gel/cream to use, therein not allowing the user a daily option of what type of lather to use.

In past a shaver made his own lather by adding warm water to a shaving soap in a mug and agitating the mixture with his brush to develop a froth of soapsuds. The lather was then applied to the face by the brush, the brush being used to collect the lather from the mug. While this process is time consuming it did allow a user to determine the type of soap to use on a daily basis. And while this time consumption led to the development of a more convenient aerosol canisters in which lather under pressure is dispensed by pressing a release valve. It does present its limitations with respect to the temperature and type of lather to use. Furthermore, while aerosol canisters are convenient some argue that the lather they produce is in some respects inferior to the self-made type.

### SUMMARY OF THE INVENTION

According to an aspect of some embodiments of the present invention there is provided a device for generating lather comprising:

a. a capsule compartment sized and shaped to receive at least one capsule;

b. a liquid source fluidly connected to said capsule compartment to provide at least one liquid to said compartment;

c. a lather generating cell that generates lather from at least one lather-generating raw material and said at least one liquid;

d. a receptacle positioned and fluidly coupled to receive said generated lather; and

e. a temperature modulator positioned to modify a temperature of at least a part of said device and thereby modifying a temperature of said generated lather.

According to some embodiments of the invention, said capsule compartment acts as said lather generating cell.

According to some embodiments of the invention, said lather generating cell is in direct communication via a channel and wherein said channel conveys said generated lather to said receptacle.

According to some embodiments of the invention, said receptacle comprises at least one orifice acting as said channel.

According to some embodiments of the invention, said lather generating cell comprises at least one rotor, which rotates to generate said lather.

According to some embodiments of the invention, said at least one rotor is in the form of one or more of an impeller; a brush; a centrifugal component and/or any combination thereof.

According to some embodiments of the invention, said liquid consists essentially of water. According to some embodiments of the invention, said liquid includes less than 30% water by volume.

According to some embodiments of the invention, the device further comprising at least one of said capsule.

According to some embodiments of the invention, said capsule comprises multiple compartments; and wherein each compartment of said multiple compartments contain a different material.

According to some embodiments of the invention, said different material is selected from the group consisting of at least one lather-generating raw material, aftershave, softener, perfume, medicaments, said at least one liquid, water and any combination thereof. According to some embodiments of the invention, said liquid source is located in said capsule.

According to some embodiments of the invention, said liquid source comprises a port for water provision by a user.

According to some embodiments of the invention, said receptacle is located at a top-most part of said device.

According to some embodiments of the invention, said device further comprises a controller.

According to some embodiments of the invention, said controller comprises a timer that finishes a cycle of generating lather in 30 seconds or less.

According to some embodiments of the invention, said controller comprises a communications module configured to communicate with at least one external device.

According to some embodiments of the invention, said lather generating cell is sized and shaped to include said rotor and space for at least 20% of the lather that is being generated.

According to some embodiments of the invention, said temperature modulator is an electrical temperature modulator.

According to some embodiments of the invention, said temperature modulator provides hot air or cold air.

According to some embodiments of the invention, said device receives power from an external power source.

According to some embodiments of the invention, said device receives power from an internal power source; and said device is cordless.

According to some embodiments of the invention, said device is waterproof.

According to some embodiments of the invention, said lather generating cell includes said capsule compartment.

According to some embodiments of the invention, said temperature modulator modulates temperatures from about 4 degrees Celsius to about 40 degrees Celsius.

According to some embodiments of the invention, said temperature modulator modulates temperatures below 70 degrees Celsius.

According to some embodiments of the invention, said device produces no pressure in said lather generating cell during said lather generation.

According to some embodiments of the invention, said device produces a pressure of less than 15 bar during said lather generation.

According to some embodiments of the invention, said capsule comprises a shape selected from the group consisting of: a dome, a pill, a tablet, a geometrical shape, a non-geometrical shape and/or any combination thereof.

According to some embodiments of the invention, said capsule compartment is sized and shaped according to said capsule shape.

According to an aspect of some embodiments of the present invention there is provided a method of generating lather in a lather generating device, comprising:

a. receiving at least one capsule comprising at least one lather-generating raw material into a capsule compartment;

b. receiving at least one liquid from at least one liquid source;

c. generating lather in a lather generating cell by mixing said at least one lather-generating raw material and said at least one liquid;

d. moving said generated lather into a receptacle.

According to some embodiments of the invention, said generating comprises generating in said capsule compartment.

According to some embodiments of the invention, said method comprises modifying a temperature of one or more of said liquid; said lather generating cell; said receptacle; and any combination thereof.

According to some embodiments of the invention, said modifying comprises heating or cooling at least one selected from the group consisting of: said liquid; said lather generating cell; said receptacle; and any combination thereof.

According to some embodiments of the invention, said modifying comprises providing hot air or cold air into said lather generating cell during said generating.

According to some embodiments of the invention, said generating comprises forming said lather by rotating a rotor in said generating cell.

According to some embodiments of the invention, said at least one rotor is in the form of at least one selected from the group consisting of: at least one impeller; at least one brush; at least one centrifugal component; and any combination thereof.

According to some embodiments of the invention, said rotating comprises rotating in a center of said cell, in a periphery of said cell and/or a combination of both.

According to some embodiments of the invention, said rotor extends over a length of less than 50% of said cell.

According to some embodiments of the invention, the method further comprising providing at least one other material with said at least one lather-generating raw material.

According to some embodiments of the invention, the method further comprising providing said at least one capsule with a plurality of compartments; and wherein each compartment of said multiple compartments contain a different material.

According to an aspect of some embodiments of the present invention there is provided a device for generating lather comprising:

a. a capsule compartment sized and shaped to receive at least one capsule;

b. a liquid source fluidly connected to said capsule compartment to provide at least one liquid to said compartment;

c. a lather generating cell that generates lather from at least one lather-generating raw material and said at least one liquid;

d. a receptacle positioned and fluidly coupled to receive said generated lather; wherein said capsule compartment acts as said lather generating cell.

According to an aspect of some embodiments of the present invention there is provided a device for generating lather comprising:

a. a capsule compartment sized and shaped to receive at least one capsule;

b. a liquid source fluidly connected to said capsule compartment to provide at least one liquid to said compartment;

c. a lather generating cell that generates lather from at least one lather-generating raw material and said at least one liquid;

d. a receptacle positioned and fluidly coupled to receive said generated lather; wherein said lather generating cell is in direct communication via a channel and wherein said channel conveys said generated lather to said receptacle and wherein said receptacle comprises at least one orifice acting as said channel.

According to an aspect of some embodiments of the present invention there is provided a device for generating lather comprising:

a. a capsule compartment sized and shaped to receive at least one capsule;

b. a liquid source fluidly connected to said capsule compartment to provide at least one liquid to said compartment;

c. a lather generating cell that generates lather from at least one lather-generating raw material and said at least one liquid;

d. a receptacle positioned and fluidly coupled to receive said generated lather; wherein said receptacle is located at a top-most part of said device and said receptacle comprises at least one orifice at the bottom from which said generated lather enters said receptacle.

According to some embodiments of the invention, any of the abovementioned devices further comprising a temperature modulator configured to modify a temperature of at least one of said capsule compartment, said liquid source, said lather generating cell and said receptacle.

According to an aspect of some embodiments of the present invention there is provided a capsule for a lather-generating device, comprising:

a. a plurality of compartments;

b. at least one lather generating raw material;

c. at least one liquid material; and

d. at least one material other than said at least one lather generating raw material and said at least one liquid material;

wherein said materials are each located in a different compartment of said plurality of compartments.

According to an aspect of some embodiments of the present invention there is provided a lather generating mechanism, comprising:

a. a compartment configured to receive a plurality of lather generating raw materials;

b. at least one rotor comprising an axis of rotation, which rotates to generate said lather;

wherein generation of lather is performed by mixing said plurality of raw materials by means of shear force between surfaces at high speeds generated by said rotating of said rotor.

According to some embodiments of the invention, said surfaces are parallel to said axis of rotation.

According to some embodiments of the invention, said surfaces are perpendicular to said axis of rotation.

There is an unmet need for, and it would be highly useful to have, a device and system for generating and dispensing a warm shaving lather where the user can have variable types and forms of lather at his disposal.

Accordingly, it is an object of this invention to provide a lather dispenser device and system which generates and dispenses a fresh supply of warm lather, where a user may select the type of lather used with each use and/or shave.

Another object of the invention is to provide a lather generating and dispensing device where water is controllably heated and mixed with a lathering agent to form a lather of the user's choice, where the lathing agent is provided in a single use capsule and/or cartridge form, the lather is then delivered to the user via a nozzle. In some embodiments, the capsule is sufficient to produce lather for a single shave while the user may alternate different types of lather compounds on a shave by shave basis, therein increasing the user personal shaving quality and control of the type of shaving lather used.

While embodiments of the present invention are conceived and described as a means for producing shaving foam, cream and/or lather, it will be readily apparent that the device is adapted to produce foams and/or lathers and/or cream for other purposes and/or products, for example including but not limited to: hair products, hygienic products, beauty and cosmetic products.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks, might be expected to use completely different methods, e.g., making use of expert knowledge and/or the pattern recognition capabilities of the human brain, which would be vastly more efficient than manually going through the steps of the methods described herein.

### BRIEF DESCRIPTION OF THE SEVERAL VIEWS OF THE DRAWING(S)

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1a-b are schematic block diagrams of an exemplary system for generating and delivering lather, according to some embodiments of the present invention;

FIGS. 2a-b are schematic block diagrams of an exemplary system for generating and delivering lather, according to some embodiments of the present invention;

FIGS. 3a-b are schematic block diagrams of an exemplary system for generating and delivering lather, according to some embodiments of the present invention;

FIG. 4 is a schematic flow chart showing a method of generating lather with the system by the user, according to some embodiments of the present invention;

FIGS. 5-6 are schematic flow charts showing a method of generating lather with the system, according to some embodiments of the present invention;

FIG. 7 is a schematic flow chart showing a method of generating lather with the system, according to some embodiments of the present invention;

FIG. 8 is a schematic block diagram of an exemplary system for generating and delivering lather, according to some embodiments of the present invention;

FIG. 9 is a schematic flow chart showing the method of generating lather with the system according to some embodiments of the present invention;

FIGS. 10a-d are schematic illustrative box diagrams of optional configuration of the system according to embodiments of the present invention;

FIG. 11 are schematic representations of a lather generating device, according to some embodiments of the present invention;

FIG. 12 are schematic representations of a lather generating device, according to some embodiments of the present invention;

FIG. 13 are schematic representations of a lather generating device comprising the mixing mechanism, according to some embodiments of the present invention;

FIG. 14 are schematic representations of a lather mixing mechanism, according to some embodiments of the present invention;

FIG. 15 are schematic representations of a lather mixing mechanism, according to some embodiments of the present invention;

FIG. 16 are schematic representations of a lather mixing mechanism, according to some embodiments of the present invention;

FIGS. 17a-d are schematic representations of a lather mixing mechanism, according to some embodiments of the present invention;

FIGS. 18a-b are schematic representations of a lather mixing mechanism, according to some embodiments of the present invention;

FIGS. 19a-c are schematic representations of head applicators, according to some embodiments of the present invention; and

FIGS. 20a-h are schematic representation of capsules and kits, according to some embodiments of the present invention.

### DESCRIPTION OF THE PREFERRED EMBODIMENTS

The principles and operation of the present invention may be better understood with reference to the drawings and the accompanying description.

The following figure reference labels are used throughout the description to refer to similarly functioning components are used throughout the specification here in below.

### Overview

An aspect of some embodiments of the invention relates to mechanically generating lather on demand from a lather capsule. In some embodiments of the invention, the lather temperature is thermally modified. Optionally or additionally, the lather is generated in a same receptacle as receives the capsule. Optionally or additionally, the lather is fed directly into a receptacle, optionally from its bottom. Optionally or additionally, the lather is generated by shear forces.

In some embodiments of the invention, the lather generating device is waterproof. In some embodiments of the invention, the lather generating device is wired and receives power from an external power source. In some embodiments of the invention, the lather generating device is wireless and receives power from an internal power source. In some embodiments, the device can be used in the shower or in proximity to wet environments.

An aspect of some embodiments of the invention relate to generating lather in a device by using at least one capsule. In some embodiments, more than one capsule is used in the generation of lather. In some embodiments, one capsule comprises raw lather generating materials and another capsule comprises additives, for example gels, perfumes, medicine and/or minerals. In some embodiments, the generated lather is provided at a determined temperature. In some embodiments, the user choses the temperature of the generated lather. In some embodiments, the temperature of the lather is kept by manipulating the temperature of the receptacle in which the lather is kept.

An aspect of some embodiments of the invention relate to using a same location for receiving a capsule and for generating lather from raw material in the capsule. In some embodiments, the lather generating compartment and the capsule compartment are located in the same place. In some embodiments, the lather generating compartment is adapted to perform as a capsule compartment. In some embodiments, the capsule compartment is adapted to perform as a lather generating compartment.

An aspect of some embodiments of the invention relate to lather mixing mechanisms. In some embodiments, the lather mixing mechanism comprises at least one rotor. In some embodiments, the rotor is rotor is in the form of at least one selected from the group consisting of: at least one impeller; at least one brush; at least one centrifugal component; and any combination thereof. In some embodiments, generation of lather is performed by mixing a plurality of raw materials and applying shear forces between surfaces at high speeds. In some embodiments, rotation of said rotor generates said shear forces. In some embodiments, the rotor extends over a length of less than 50% of the lather generating cell. In some embodiments, the rotor extends over a length of more than 50% of the lather generating cell.

An aspect of some embodiments of the invention relate to providing lather in a receptacle. In some embodiments, the receptacle is connected to a lather generating device. In some embodiments, the receptacle comprises at least one orifice in the bottom. In some embodiments, said at least one orifice is in communication to a lather generating cell, therefore, when lather is generated, the lather passes through said orifice into the receptacle.

An aspect of some embodiments of the invention relate to providing a capsule for generating lather. In some embodiments, the capsule comprises one compartment comprising raw lather generating material. In some embodiments, the capsule comprises more than one compartment. In some embodiments, each compartment of a multi-compartment capsule comprises a different material. In some embodiments, different materials are provided in different capsules, and more than one capsule is used when generating lather.

An aspect of some embodiments of the invention relate to providing a temperature modulated lather. In some embodiments, lather is provided at a temperature chosen by the user. In some embodiments, temperature modulation is performed on the lather raw materials before the generation process. In some embodiments, temperature modulation is performed on the location where the lather is being generated. In some embodiments, temperature is kept by modulation of the temperature of the receptacle where the generated lather is kept. In some embodiments, temperature modulation comprises temperatures from about 4 degrees Celsius to about 50 degrees Celsius.

### Exemplary General Device

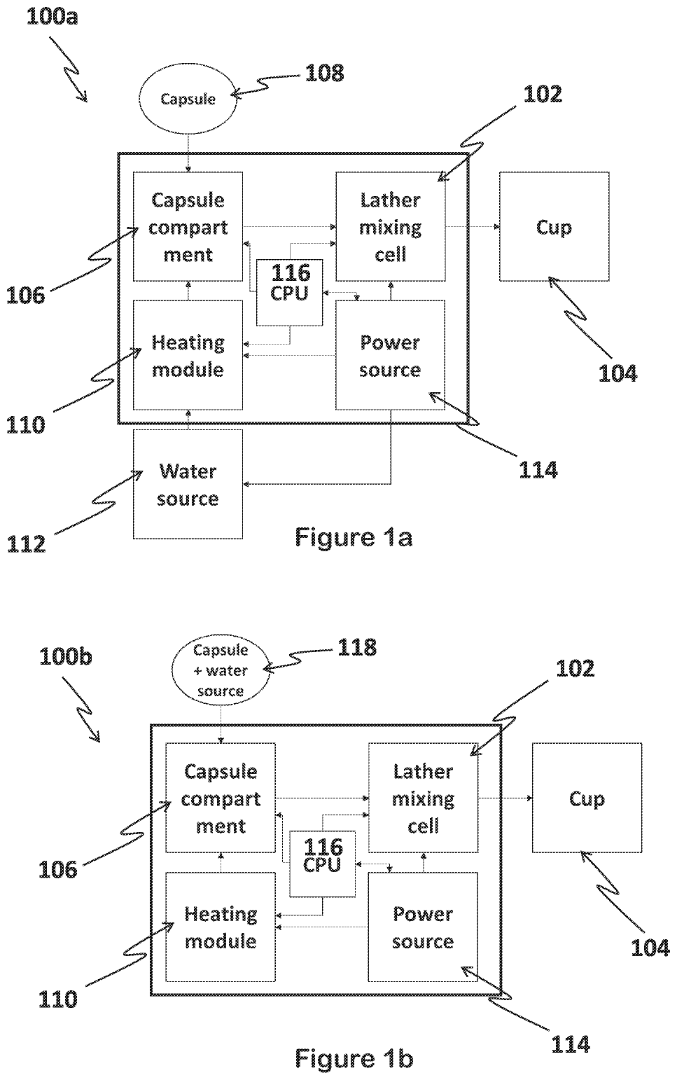

FIGS. 1(a, b), 2(a, b) and 3(a, b) are schematic diagrams of lather generating and dispensing devices 100(a, b)/200(a, b)/300(a, b) according to some embodiments of the present invention. In some embodiments, the devices comprise the same number of components. In some embodiments, the devices comprise different number of components. In some embodiments, whether a device comprise the same number of components or not, each device is adapted to perform the function of a lather generating and dispensing device, which is the generation and dispensing of lather. In some embodiments, the lather generating and dispensing device is designed to be capable of dispensing lather generated from the lathering agents stored in an insert in the form of capsule and/or cartridge, when such an insert is loaded into device within a capsule housing. Referring now to FIG. 1a showing a schematic diagram of a lather generating and dispensing device 100a, according to some embodiments of the present invention. In some embodiments, the device comprises a lather generating cell 102 where the materials are mixed and the lather is generated and then moved to a dedicated cup 104 for use. In some embodiments, the device comprises a capsule compartment 106, where the capsule 108, comprising the raw material, is inserted. In some embodiments, the device comprises a temperature modulator 110 configured to heat the water coming from the water source 112. In some embodiments, water is used to mix the lather raw materials and generate the lather. In some embodiments, liquids other than water are used to mix the lather raw materials and generate the lather. As a matter of example, water is will be used to describe some embodiments. It will be obvious to a person having skills in the art that other liquids can be used in the generating process to create the lather. In some embodiments, liquids other than water can be, for example, oils, water with additives like amino acids, salts, minerals, perfume and any combination thereof. In some embodiments, the temperature modulator can either increase or decrease the temperature of the material being treated. In some embodiments, the device comprises a power source 114 configured to provide the necessary power to active the lather generating cell 102, the temperature modulator 110, the water suction mechanisms from the water source (not shown) and the mechanisms located in the capsule compartment 106 (see below for description on mechanisms in the capsule compartment). In some embodiments, the device comprises a CPU 116 configured with instructions to control the actions of the different components of the device.

Referring now to FIG. 1b showing a schematic diagram of a lather generating and dispensing device 100b, according to some embodiments of the present invention. In some embodiments, the device comprises a lather generating cell 102 where the raw materials are mixed, and the lather is generated and then moved to a dedicated cup 104 for use. In some embodiments, the device comprise a capsule compartment 106, where the capsule 118 comprising the raw material and the necessary liquids (e.g. water) is inserted. In some embodiments, the device comprises a temperature modulator 110 configured to heat the capsule compartment 106 containing the capsule with the raw material and the water (or any other liquid). Optionally, the temperature modulator 110 heats only the capsule itself and not the whole capsule compartment 106. In some embodiments, the device comprises a power source 114 configured to provide the necessary power to active the lather generating cell 102, the temperature modulator 110 and the mechanisms located in the capsule compartment 106 (see below for description on mechanisms in the capsule compartment). In some embodiments, the device comprises a CPU 116 configured with instructions to control the actions of the different components of the device.

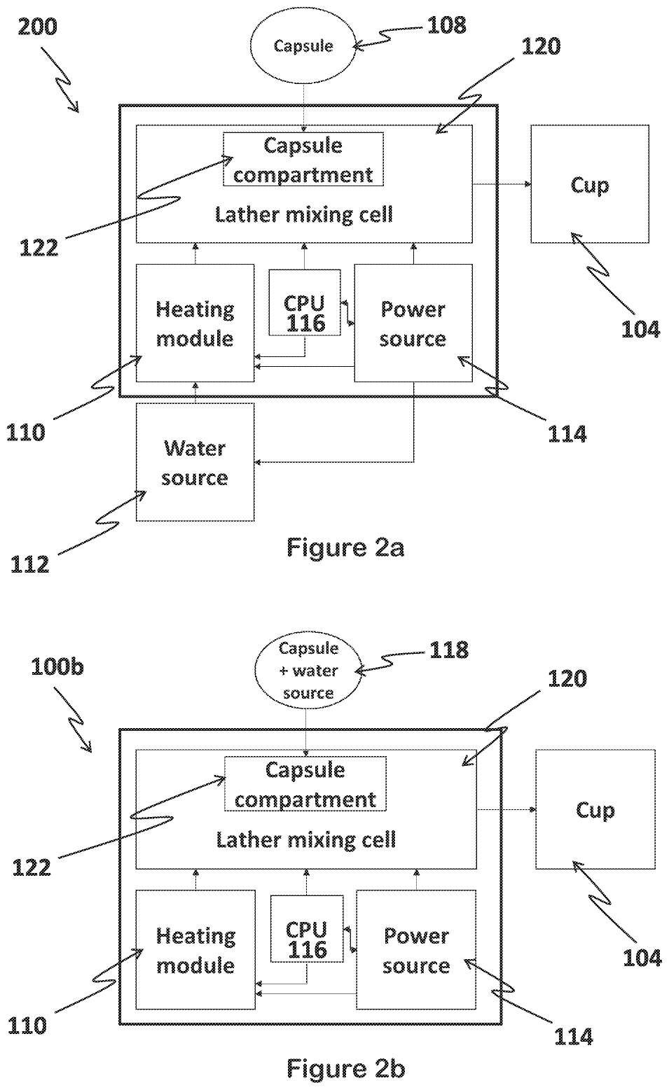

Referring now to FIG. 2a showing a schematic diagram of a lather generating and dispensing device 200a, according to some embodiments of the present invention. In some embodiments, the device comprises a lather generating cell 120 where the raw materials are mixed, and the lather is generated and then moved to a dedicated cup 104 for use. In some embodiments, the lather generating cell 120 is configured to include inside a capsule compartment 122, where the capsule 108, comprising the raw material, is inserted. In some embodiments, the device comprises a temperature modulator 110 configured to heat the water (or any other liquid) coming from the water source 112 (or any other liquid source). In some embodiments, the device comprises a power source 114 configured to provide the necessary power to active the lather generating cell 120, the temperature modulator 110, the water suction mechanisms from the water/other liquid source (not shown) and the mechanisms located in the capsule compartment 122 (see below for description on mechanisms in the capsule compartment). In some embodiments, the device comprises a CPU 116 configured with instructions to control the actions of the different components of the device.

Referring now to FIG. 2b showing a schematic diagram of a lather generating and dispensing device 200b, according to some embodiments of the present invention. In some embodiments, the device comprises a lather generating cell 120 where the raw materials are mixed, and the lather is generated and then moved to a dedicated cup 104 for use. In some embodiments, the lather generating cell 120 is configured to include inside a capsule compartment 122, where the capsule 118, comprising the raw lather material and the necessary water, is inserted. In some embodiments, the device comprises a temperature modulator 110 configured to heat the capsule compartment 122 containing the capsule with the raw material and the water (or any other liquid). Optionally, the temperature modulator 110 heats only the capsule itself and not the whole capsule compartment 122. In some embodiments, the device comprises a power source 114 configured to provide the necessary power to active the lather generating cell 120, the temperature modulator 110 and the mechanisms located in the capsule compartment 122 (see below for description on mechanisms in the capsule compartment). In some embodiments, the device comprises a CPU 116 configured with instructions to control the actions of the different components of the device.

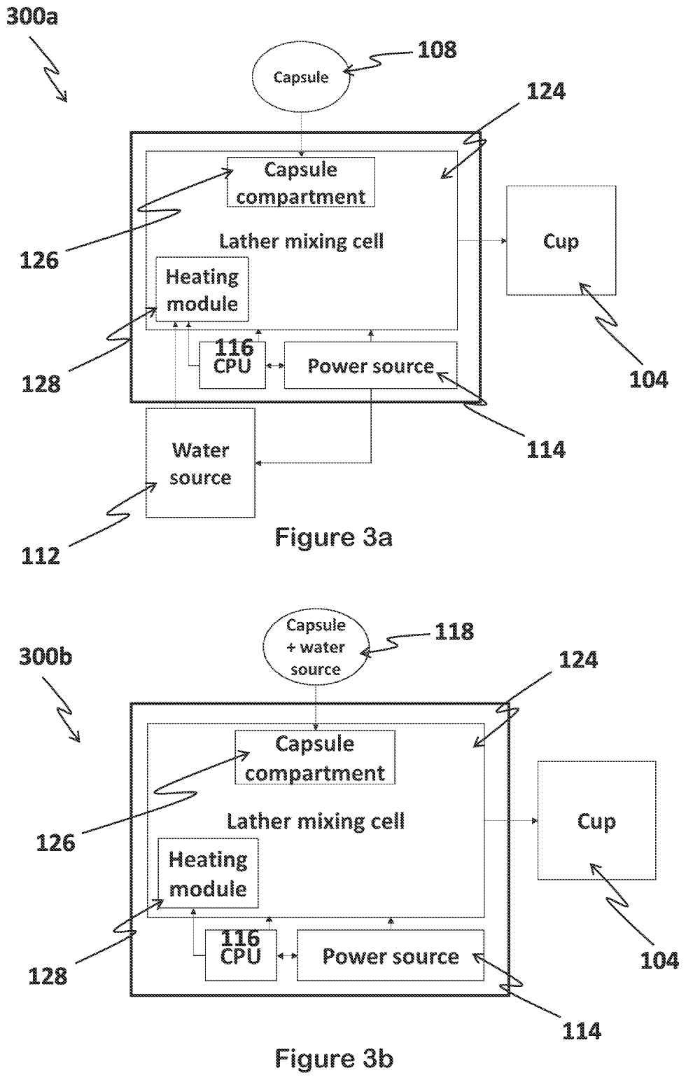

Referring now to FIG. 3a showing a schematic diagram of a lather generating and dispensing device 300a, according to some embodiments of the present invention. In some embodiments, the device comprises a lather generating cell 124 where the lather is mixed, generated and then moved to a dedicated cup 104 for use. In some embodiments, the lather generating cell 124 is configured to include inside a capsule compartment 126, where the capsule 108 comprising the raw lather material is inserted. In some embodiments, the lather generating cell 124 further configured to comprise inside a temperature modulator 128 configured to heat the water (or any other liquid) coming from the water source 112 (or any other liquid source). In some embodiments, the device comprises a power source 114 configured to provide the necessary power to active the lather generating cell 124, the temperature modulator 128, the water suction mechanisms from the water/other liquid source (not shown) and the mechanisms located in the capsule compartment 126 (see below for description on mechanisms in the capsule compartment). In some embodiments, the device comprises a CPU 116 configured with instructions to control the actions of the different components of the device.

Referring now to FIG. 3b showing a schematic diagram of a lather generating and dispensing device 300b, according to some embodiments of the present invention. In some embodiments, the device comprises a lather generating cell 124 where the lather is mixed, generated and then moved to a dedicated cup 104 for use. In some embodiments, the lather generating cell 124 is configured to include inside a capsule compartment 126, where the capsule 118 comprising the raw lather material and the necessary water (or any other liquid) is inserted. In some embodiments, the lather generating cell 124 is further configured to comprise inside a temperature modulator 128 configured to heat the capsule compartment 124 containing the capsule with the raw material and the water. Optionally, the temperature modulator 128 heats only the capsule itself and not the whole capsule compartment 124. In some embodiments, the device comprises a power source 114 configured to provide the necessary power to active the lather generating cell 124, the temperature modulator 128 and the mechanisms located in the capsule compartment 126 (see below for description on mechanisms in the capsule compartment). In some embodiments, the device comprises a CPU 116 configured with instructions to control the actions of the different components of the device.

In relation to FIGS. 1(a, b), 2(a, b) and 3(a, b), it is included in the scope of the invention that, in some embodiments, any combination of configurations of the lather generating cell (102, 120, 124), the capsule compartment (106, 122, 126), the heating element (102, 120, 126), the power source 114, the CPU 116 and the optionally external water source/other liquid source 112 are possible. Furthermore, it is also included in the scope of the invention that, in some embodiments, any combination of unified configurations of lather generating cell (102, 120, 124), the capsule compartment (106, 122, 126) and the heating element (102, 120, 126) are possible.

In some embodiments, any of the lather generating devices disclosed herein are waterproof and/or water resistant, thereby allowing a user to use the device, for example, at the shower.

### Exemplary Embodiments of Power Sources

In some embodiments, the power source 114 that provides the required energy to the device is an external power source (e.g. a plug connected to the electricity). In some embodiments, the power source 114 that provides the required energy to the device is an internal power source (e.g. batteries, rechargeable batteries). In some embodiments, the device is configured to accept energy from either/or both internal and external the power sources 114 (e.g. a plug connected to the electricity and internal batteries and rechargeable batteries). In some embodiments, where the device is a portable device, other methods of energy source are used, for example, solar energy, manual activation of the device, etc.

### Exemplary Embodiments of Water/Liquid Sources

In some embodiments, the water/liquid source 112 that provides the required water/liquid to the device to create the lather is an external water/liquid source (e.g. a tube connected on one side to the device and on the other to an external water plumbing). In some embodiments, the water/liquid source 112 that provides the required water/liquid to the device to create the lather is an internal water source (e.g. a dedicated container inside the device configured to be filled with water manually by the user). In some embodiments, the device is configured to accept water/liquid from either/or both internal and external the water/liquid sources 112 (e.g. a tube connected on one side to the device and on the other to an external water plumbing and a dedicated container inside the device configured to be filled with water/liquid manually by the user).

In some embodiments, where the water/liquid source is not included in the capsule, the device comprises dedicated pumps configured to mobilize the water/liquid from one point (either from outside water/liquid sources or dedicated internal water/liquid container) into another (capsule compartment and/or lather generating cell and/or temperature modulator).

In some embodiments, when a water/liquid compartment is used, it may reside inside the main device or it can be in a separate independent housing for receiving and holding a volume of water. In some embodiments, the external water/liquid container comprises a valve to control the flow and delivery of water/liquid from the container into the main device.

In some embodiments, the device comprises at least one water/liquid pump configured to pump water/liquid from either source (external or internal) via piping towards the capsule compartment and/or the lather generating cell. Accordingly, in some embodiments, the pump is configured to deliver the sufficient amount of water/liquid under pressure through the device. Preferably, the pump is configured to be operational at a pressure of about 1-2 bar. In some embodiments, the pump is configured to be operated at a pressure of up to about 15 bar. In some embodiments, as stated above, the capsule 118 itself comprises the water/liquid required to the device to create the lather (see below for more information on capsules).

### Exemplary Embodiments of Temperature Modulators

In some embodiments, the temperature modulator is an electrical temperature modulator configured to provide the heat necessary in the creation of lather. For example, the temperature modulator may be configured to a power profile from about 3 Watts and up to about 300 Watts, more preferably temperature modulator utilizes a power profile of about 100 Watts.

In some embodiments, the temperature modulator heats the water/liquid that comes from the water/liquid source. In some embodiments, the temperature modulator heats the lather generating cell thereby heating the lather while is being created inside the lather generating cell. In some embodiments, the temperature modulator heats the capsule compartment thereby heating the raw materials before and/or while entering the lather generating cell.

In some embodiments, the device comprise multiple temperature modulators configured to heat, either independently or all at once, the water/liquid that comes from the water/liquid source, the lather generating cell and/or the capsule compartment. In some embodiments, the multiple heating sources are activated according to the method of producing lather: the water/liquid from the water source is heated while entering the device, before that and/or during and/or after that the capsule compartment is heated to heat the raw materials, and lastly before that and/or during and/or after that the lather generating cell is heated during the creation of the lather.

In some embodiments, the device further comprises another temperature modulator for the cup configured to heat the cup. This could be advantageous in cases where, for example, the exterior environment where the device is located is cold and the user would like to keep the lather that exited the device warm.

In some embodiments, the temperature modulator is configured as a hot/cold-air temperature modulator. In some embodiments, hot air is used to heat-up the lather. In some embodiments, heating the lather with hot-air is performed during the lather generating procedure. In some embodiments, heating the lather with hot-air is performed after the lather generating procedure to keep the made lather at the required temperature until it is used.

In some embodiments, the temperature modulator is configured to decrease, increase or maintain the temperature of the liquid, the lather generating cell, the capsule, the cup and any combination thereof.

In some embodiments, the user choses the temperature of the lather final product. In some embodiments, the temperature of the lather is between 4 degrees Celsius and 40 degrees Celsius. Optionally, between 8 degrees Celsius and 30 degrees Celsius. Optionally, between 14 degrees Celsius and 20 degrees Celsius. For example 5 degrees Celsius, 18 degrees Celsius, 35 degrees Celsius. Optionally at room temperature.

### Exemplary Embodiments of Lather Mixing/Generating Cells

In some embodiments, the device comprises a lather generating cell. In some embodiments, the cell comprises a mechanical mixing component. In some embodiments, the lather generating cell comprises a mixing chamber and mechanical means to ensure appropriate mixing and later generation. For example, lather generating cell may for example feature a driven rotor in the form of an impeller, a propeller, an agitator, a mixing plate, a mixing rod, the like or any combination thereof. In some embodiments, lather generating cell is driven an actuator such as a motor, a piezoelectric element, the like or any combination thereof. For example, the lather generating cell is provided in the form of mixing rod that is introduced into at least one or capsule and/or capsule housing to facilitate mixing of agents forming lather. Optionally lather generating cells are provided in the form of an agitator that agitates the capsule within housing. Optionally, the lather generating cell is in the form of an impeller and/or mixing plate may be coupled to a motor or the like actuator the cause lathering agents, water/liquid, and/or air to mix as it is generated within housing and/or prior to its delivery via nozzle and/or into a cup. In some embodiments, the lather generating cell is provided with an electronics module to at least control the rate and timing of operation to optimize generation of lather.

In some embodiments, the generation of lather is performed by mixing the raw materials by means of shear between surfaces at high speeds. In some embodiments, surfaces comprising different textures are moved at high speeds one in relation to another. In some embodiments, one surface is static and the other moves. In some embodiments, both surfaces move at high speeds.

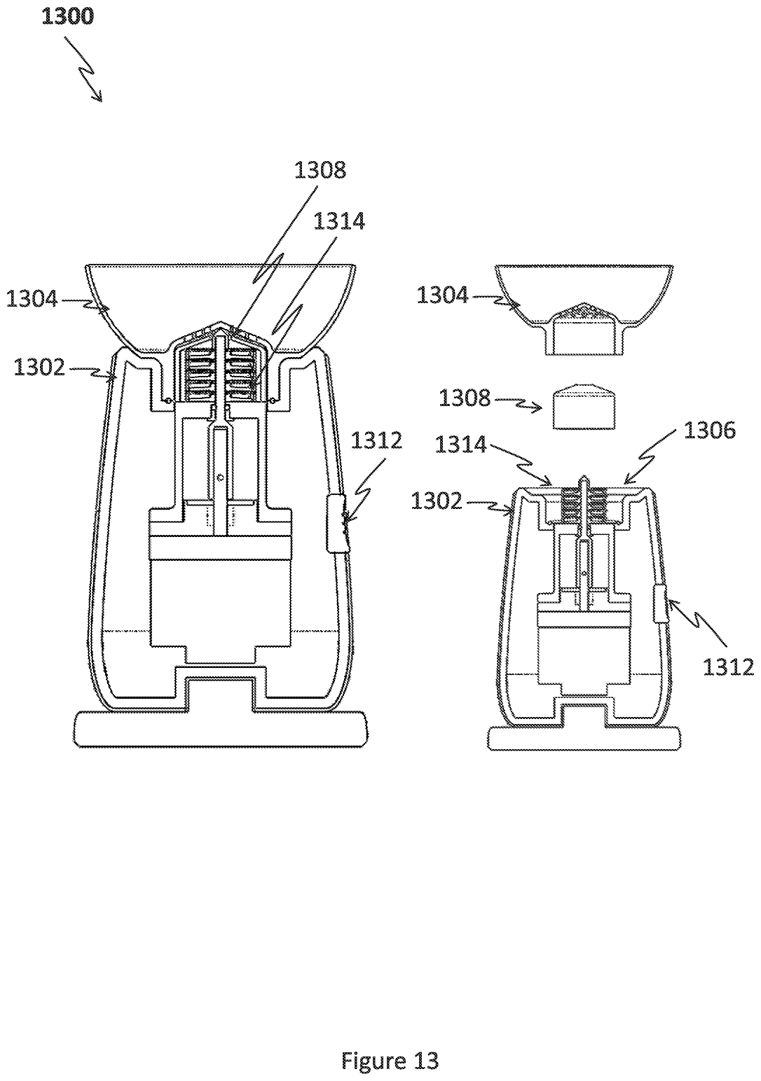

Further examples of lather mixing cells and mechanisms are disclosed below and in FIGS. 13, 14, 15, 16, 17 and 18.

### Exemplary Embodiments of Capsule Compartments

In some embodiments, capsule housing is in fluid communication with a nozzle or a cup to deliver the lather generated with the device.

In some embodiments, the capsule housing is provided to receive capsule until such a time that later is generated and delivered through a nozzle or into a cup.

In some embodiments, housing may provide a mixing chamber where contents of capsule in the form of lather agents may be mixed with water/liquid and/or air. In some embodiments, mixing to generate lather may take place within capsule housing. In some embodiments, mixing to produce lather may take place within a dedicated portion of capsule housing disposed between capsule and a nozzle or a cup (receptacle). In some embodiments, the capsule compartment is configured to receive raw materials not included in a capsule, for example, a user can pour directly into the compartment raw liquid lather material and water and activate the device.

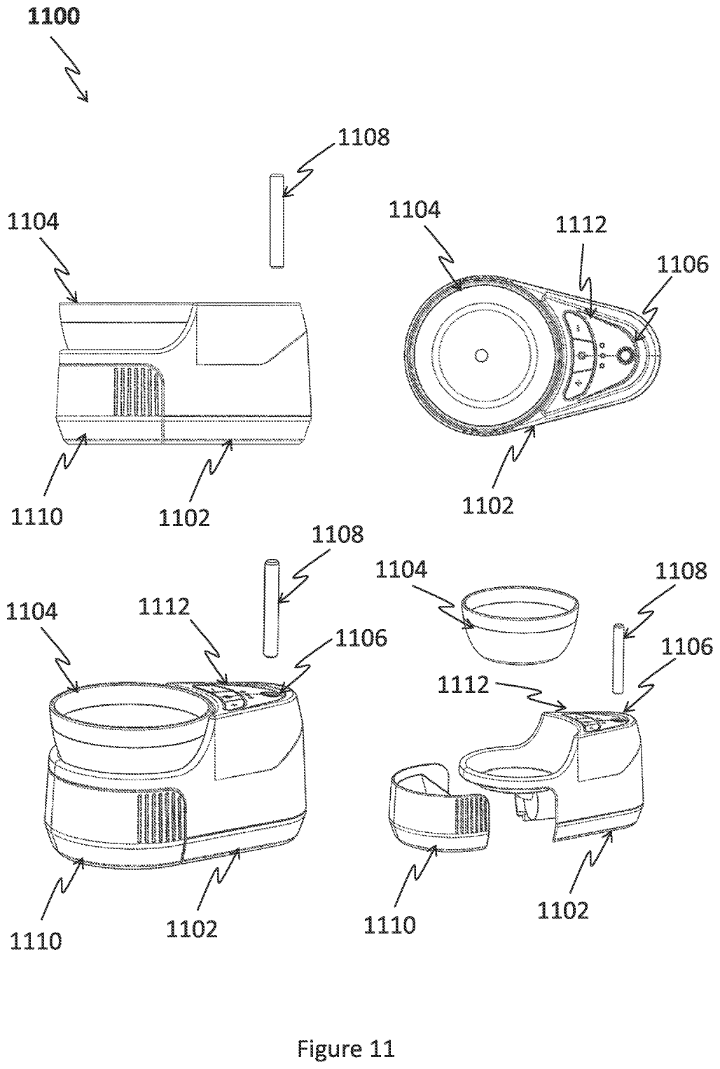

Further examples of capsule compartments and configuration for capsule compartments are disclosed below and in FIGS. 11, 12, 13, 14, 15, 16, 17 and 18.

### Exemplary Embodiments of Capsules

Capsules or the like cartridge and/or inserts may be provided in optional forms and may contain at least one or more agents and/or precursors for forming a lather such as shaving cream. In some embodiments, the capsule comprises a housing for containing at least one or more lather producing agents and/or precursors. In embodiments agents may be provided in optional forms, consistencies, and states for example including but not limited to fluid, liquid, gel, gas, solid, freeze dried, plasma, the like or any combination thereof. For example, the agents may in fluid form, loosely packed particles, compressed granulated particles, or a mixture thereof.

In some embodiments, the capsule housing is provided in optional forms for example including a rigid housing, a loose form packaging, and flexible housing. In some embodiments, the capsule housing is provided from any materials conducive and capable of for both storing agents and to facilitate forming lather when agents are exposed and/or introduced to water/liquid. For example, capsule housing may be formed from any material or a combination of materials for example including but not limited to metals, metallic alloys, polymers, plastics, hard plastics, flexible materials, the like or any combination thereof.

In some embodiments, the capsule may comprise more than one compartments, for example, the housing has at least two sub-compartments. In such a multi compartment housing, each compartment may contain a different lathering agent.

In some embodiments, at least one face of the capsule may form a filter through which the prepared lather is delivered.

In some embodiments, at least one face of the housing may form a filter through which the prepared later is delivered.

In some embodiment a filter (not shown) may be disposed as part of capsule housing to facilitate lather production.

In some embodiments, capsules comprise an external material adapted to be dissolved by either a liquid and/or heat and/or physical puncture of the external material. In some embodiments, once the external material is dissolved or punctured, the contents of the capsule are released.

In some embodiments, the capsules comprise at least one electronic identification device in the form of, for example, QR, RFID, picture recognition, etc. In some embodiments, each type of capsule comprise its own identification marker that is recognized by the device, as disclosed herein.

In some embodiments, the capsules are used only once. In some embodiments, capsules can be used a plurality of times.

In some embodiments, more than one capsule is used. In some embodiments, one capsule comprises generic lather raw materials and another capsule comprises additives to the lather. For example, the second capsule may comprise specialized gels, perfumes, medicine, minerals and more.

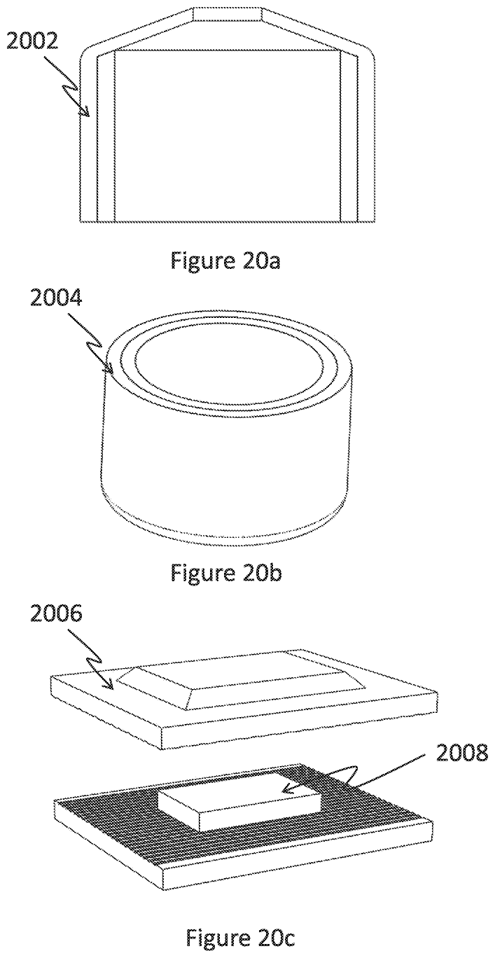

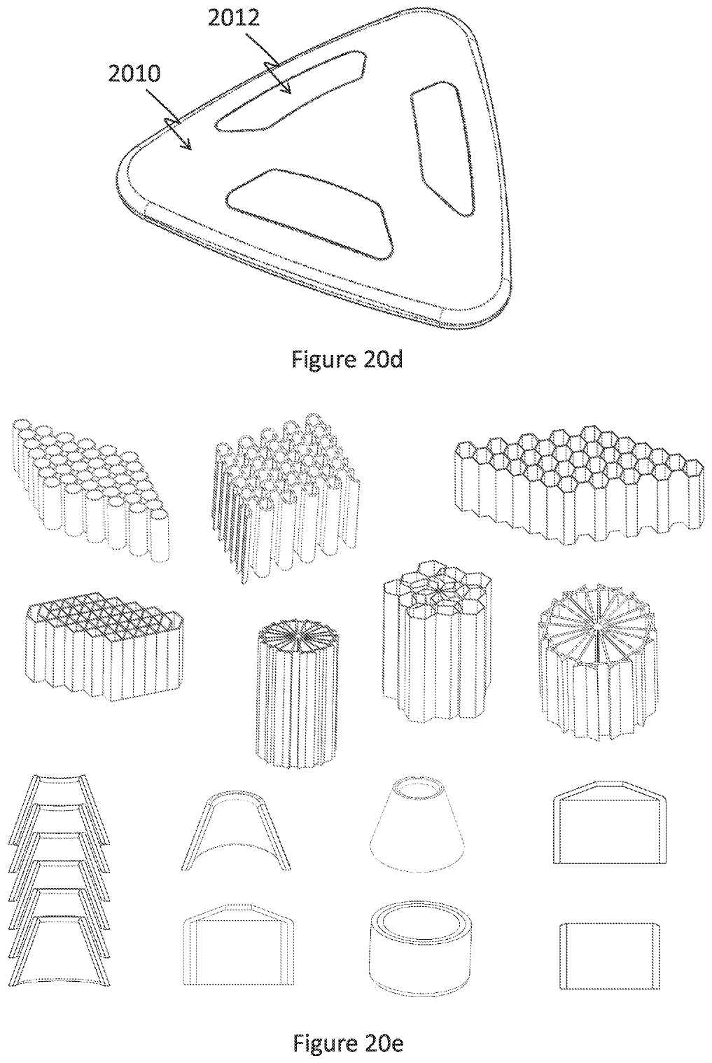

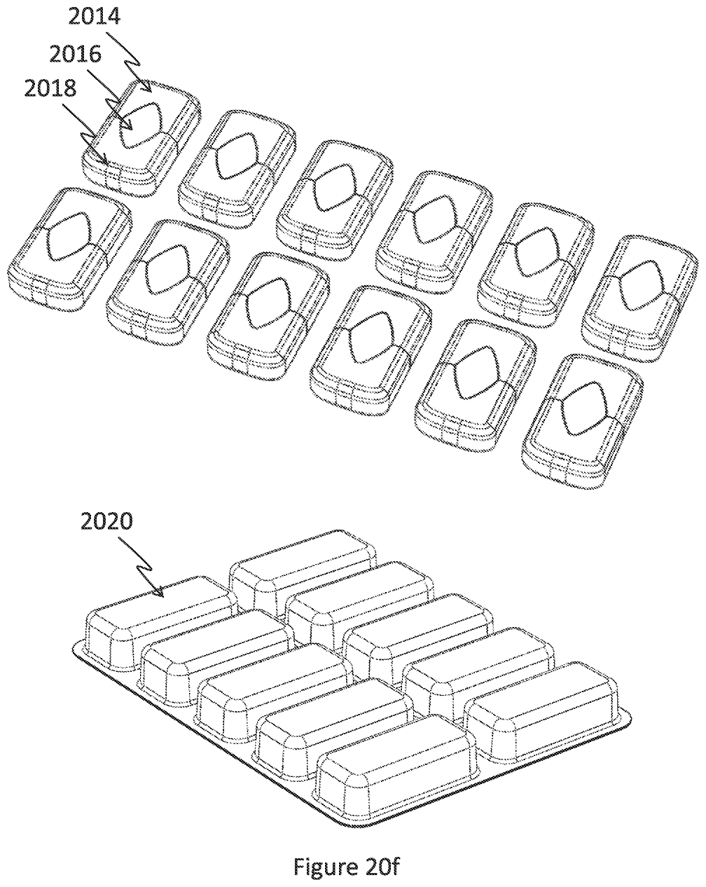

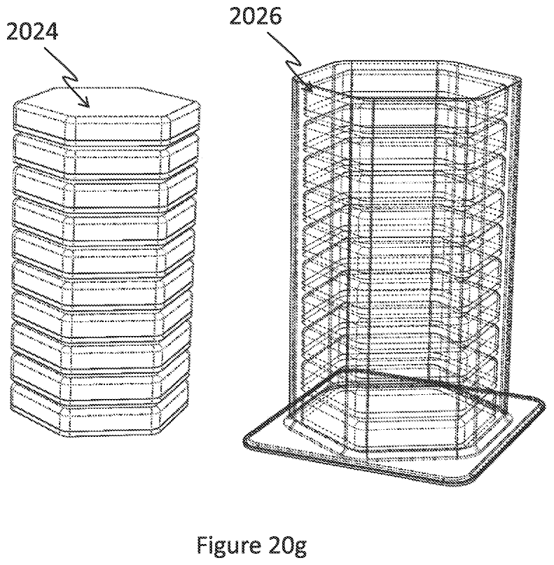

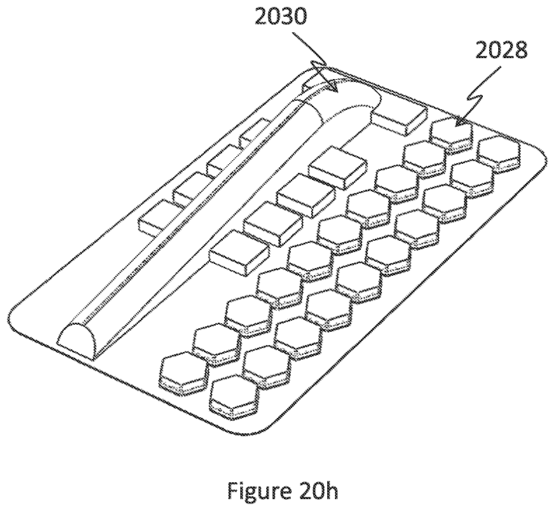

Further examples of capsules and configuration for capsules are disclosed below and in FIGS. 20a-h.

### Exemplary Embodiments of Circuity/CPU/Controller

Device and modules therein are rendered operational with circuity and electronics modules comprising a plurality of optional sub-modules for example including but not limited to a power supply sub-module, controller and/or processor sub-module, human interface sub-module, and memory sub-module. In some embodiments, electronics module may further comprise a communication module sub-module.

In some embodiments, processor sub-module provides the necessary processing hardware and/or software necessary to render the device functional.

In some embodiments, power sub-module provides the necessary hardware and/or software to power the device therein rendering the device operational.

In some embodiments, human interface sub-module provides the necessary processing hardware and/or software necessary to provide the device with the ability to interface with the user in at least one or more facets. In some embodiments, a human interface sub-module may for example include but is not limited to at least one or more of display, buttons, input keyboard, and light emitting diode displays the like or any combination thereof.

In some embodiments, a memory sub-module provides the necessary memory capabilities both in the form of hardware and/or software necessary to render the device functional.

In some embodiments, a communication sub-module provides the necessary processing hardware and/or software necessary to allow the device to communicate with at least one or more communication and processing device, for example, in the form of a computer, server, smartphone, mobile telephone, or the like communication and processing device. In some embodiments, the communication sub-module may utilize any communication protocol as is known in the art for example including but not limited to wireless communication, wireless fidelity (WIFI), near field communication (NFC), RF communication, optical communication, IR communication, BLUETOOTH, the like or any combination thereof.

In some embodiments, a communication submodule of electronics module may be in wireless communication with at least one or more communication and processing device to manage and/or monitor shaving use of at least one or more of lather, blades and/or razors. In some embodiments such use monitoring may be utilized to automate purchase and/or ordering of new lather capsules and/or razor blades (not shown) or the like shaving accessories or personal care items, for example, including but not limited to balms, creams, gels, after-shave, cologne, perfumes, facial towels the like or any combination thereof.

In some embodiments, the device and/or systems are fit with a user safety and/or counterfeit measures to ensure that the device and/or system is used only with authorized and/or authentic capsules. In some embodiments, such a safety measures ensure that a user is not exposed to harmful agents and/or ingredients that may be utilized by a counterfeit lather capsule and/or lathering agent. In some embodiments, such safety measures are rendered with at least one or both of electronics module or capsule housing.

For example, electronics module and/or capsule housing may be utilized to facilitate electronic identification and/or verification of the authenticity and/or manufacturing integrity of capsule. In some embodiments, the capsule is provided with electronic identification, for example, including but not limited to a readable RFID tag and/or barcode or the like identification means that may be read and/or authenticated with at least one of electronics module and/or capsule housing.

For example, in some embodiments, the capsule housing comprises a mechanical identification member configured to match and/or cooperate with a matching and/or corresponding identification member provided on the capsule more preferably along the capsule housing.

### Exemplary Complementary Hardware

In some embodiments, the device comprises dedicated hardware configured to interconnect the device to a plurality of services provided over the internet. In some embodiments, the device comprises a plurality of sensors that monitor the performance of the device and, in some embodiments, the information is sent to dedicated servers where dedicated feedback messages are sent to the user. In some embodiments, the information collected is time that the device has been used, the type of capsule that is used, the sensed temperatures, the chosen temperatures by the user, user identification and more. For example, the user is notified when is time to change the disposable propellers of the lather mixing cell. Another example, the user is notified when it is time to buy new capsules.

### Exemplary Air-Compressor

In some embodiments, as stated above, the device further comprises an air pump and/or a compressor. In some embodiments device may optionally further feature an air compressor. In such embodiments air compressor may provide for cleaning piping within device and in particular nozzle. Air compressor may further be utilized to delivered air under pressure into at least one of chamber and/or capsule to facilitate generation of lather by way of air delivery. Most preferably control air pup is provided with electronic module so as to control the delivery rate, overall volume of air delivery and timing of air delivery. In some embodiments, the air compressor delivers hot air, as disclosed above.

### Exemplary Methods

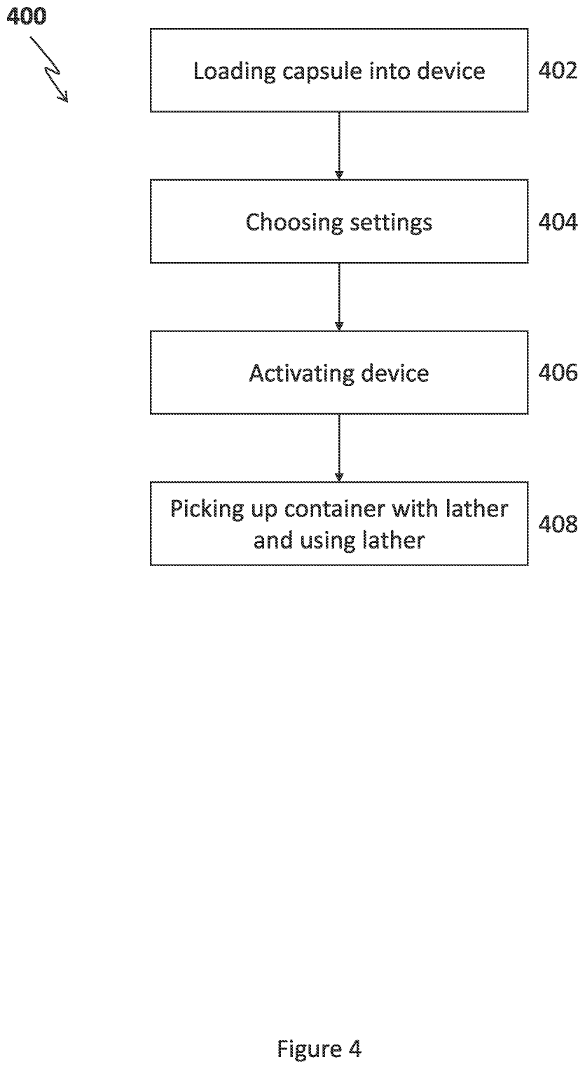

Referring now to FIG. 4 showing a flowchart of a method 400 of use of the lather generating and dispensing device, according to some embodiments of the present invention. In some embodiments, the user begins by loading a capsule into the device 402. In some embodiments, the user then continues by choosing the operational settings of the machine 404. For example, in some embodiments, the user can choose the temperature of the lather, how much lather is produced, concentration of lather according to quantity of water that is used during the generation of the lather, a time of activation of the device if the user wants the lather to be ready at a certain time (in the morning for example). In some embodiments, the user then continues by activating the device 406, and after a few minutes, picking up the container with the lather and using the lather 408. In some embodiments, when the device is set to automatically generate the lather, the user does not need to activate the device, since the device will activate itself at the required time.

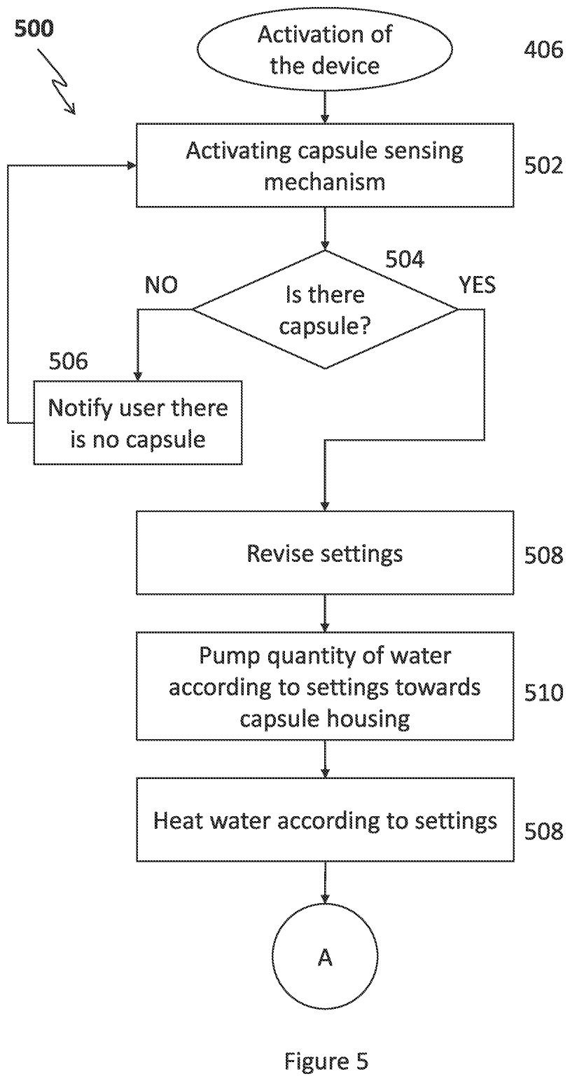

Referring now to FIG. 5 showing a flow chart of a method 500 for producing lather in the lather generating and dispensing device where the device is connected to an/or comprises a water source, according to some embodiments of the present invention.

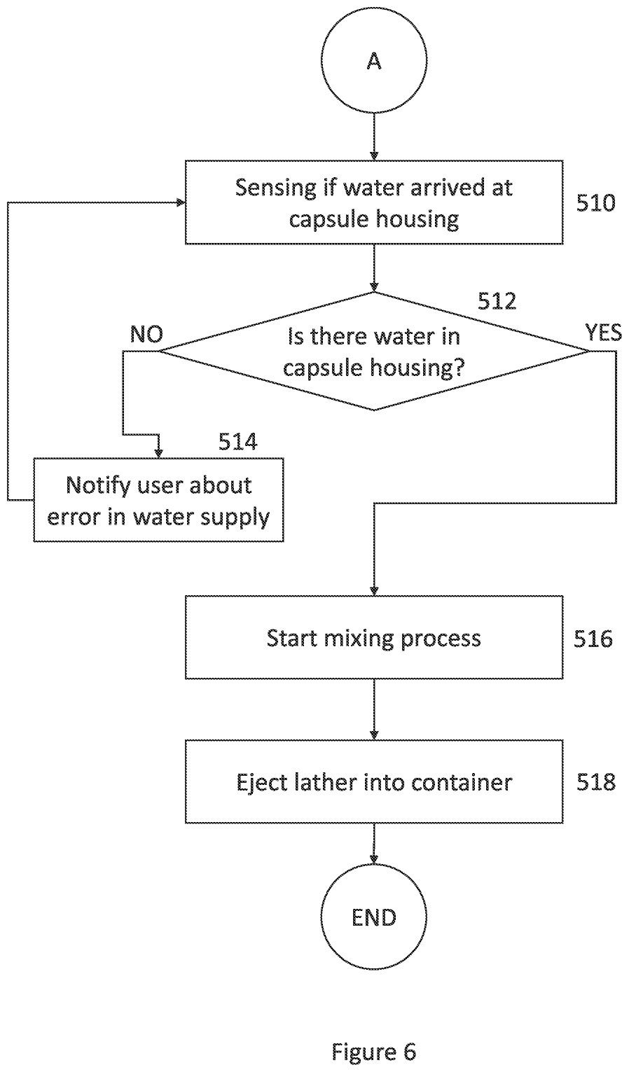

In some embodiments, the method begins with the activation of the device 406 by the user, as explained above. In some embodiments, after the activation, the device activates the capsule sensing mechanism 502, which evaluates if a capsule was loaded and/or received into device within capsule housing 504. In some embodiments, if the machine senses that there is no capsule in the capsule housing, the device notifies the user that there is no capsule 506. In some embodiments, notifications to the user are displayed on a screen, or with light emissions on the device, or any other known mechanism known in the art. In some embodiments, the device continues to sense if there is capsule until a positive outcome of the sensing is achieved. In some embodiments, when the device confirms that there is a capsule in the capsule housing, the device revises the chosen settings of the user 508. In some embodiments, the device then pumps the necessary quantity of water or any other liquid according to the settings from the water source or any other liquid source towards the capsule housing 510. In some embodiments, on the path from the water/other liquid source to the capsule housing the water/other liquid is heated according to the settings 508. (Flowchart continues following letter “A” in FIG. 6). In some embodiments, the device then activates the sensors 510 that check if water/liquid is arriving to the capsule housing 512. In some embodiments, if the machine senses that water/liquid is not arriving to the capsule housing, the device notifies the user that there is a problem with the water/liquid 514. In some embodiments, when the device confirms that there is water/liquid arriving to the capsule housing, the device commences the mixing process 516. In some embodiments, the lather then is ejected into the lather container 518, ready to be used by the user.

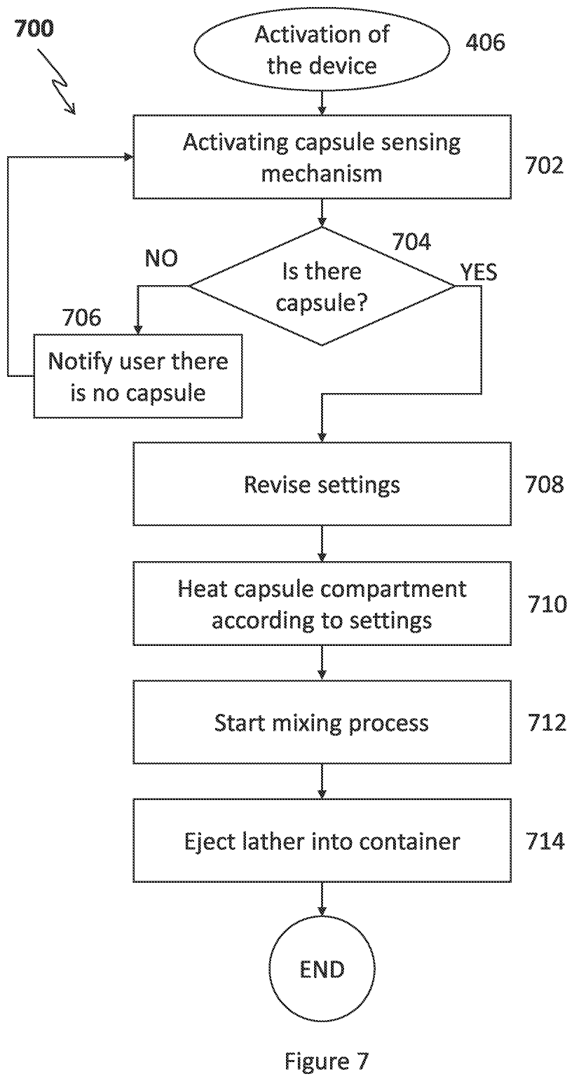

Referring now to FIG. 7 showing a flow chart of a method 700 for producing lather in the lather generating and dispensing device where the water source or any other liquid source is included in the capsule, according to some embodiments of the present invention.

In some embodiments, the method begins with the activation of the device 406 by the user, as explained above. In some embodiments, after the activation, the device activates the capsule sensing mechanism 702, which evaluates if a capsule was loaded and/or received into device within capsule housing 704. In some embodiments, if the machine senses that there is no capsule in the capsule housing, the device notifies the user that there is no capsule 706. In some embodiments, notifications to the user are displayed on a screen, or with light emissions on the device, or any other known mechanism known in the art. In some embodiments, the device continues to sense if there is capsule until a positive outcome of the sensing is achieved. In some embodiments, when the device confirms that there is a capsule in the capsule housing, the device revises the chosen settings of the user 708. In some embodiments, the device then begins warming the capsule housing according to the settings 710. In some embodiments, the device then begins the mixing process 712. In some embodiments, the lather then is ejected into the lather container 714, ready to be used by the user.

### EXAMPLES

Reference is now made to the following examples, which together with the above descriptions illustrate some embodiments of the invention in a non limiting fashion.

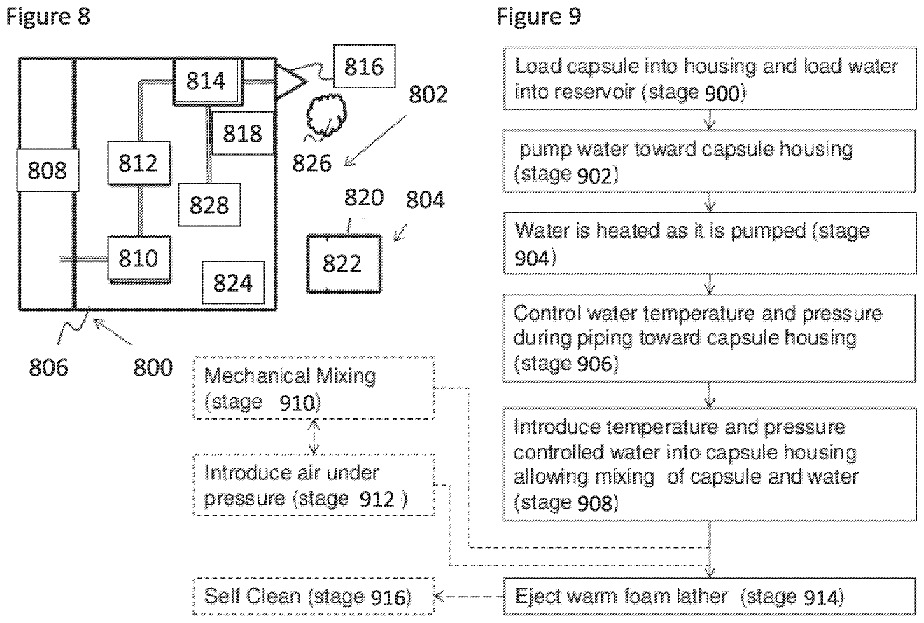

A schematic illustrative diagram of a lather generating and dispensing device 800 of the later generating system 802 according to embodiments of the present invention is shown in FIG. 8.

System 802 comprises a lather generating and dispensing device 800 for generating and dispensing lather from a capsule 804. The capsule/cartridge 804 comprising at least one or more lather agents and/or precursor, configured to, and capable of generating a lather when water is introduced and/or mixed with the capsule's contents.

The lather generating and dispensing device 800 generally comprises a housing 806, a water reservoir 808 for storing water, a water pump 810, a heating module 812, a capsule housing 814 for receiving a capsule 804, a dispensing nozzle/spout 816 for dispensing the lather, and an electronics and circuitry module 824 for controlling and rendering device 800 operational.

In some embodiments device 800 may be further feature an air pump and/or compressor 828.

In some embodiments device 800 may be further feature a mechanical mixing module 818.

The lather generating and dispensing device 800 is designed to be capable of dispensing lather generated from the lathering agents stored in an insert in the form of capsule and/or cartridge 804, when such an insert 804 is loaded into device 800 within a capsule housing 814.

Capsule 804 or the like cartridge and/or inserts may be provided in optional forms and may contain at least one or more agents and/or precursors for forming a lather such as shaving cream. Capsule 804 forms a housing 820 for containing at least one or more lather producing agents and/or precursors 822. In embodiments agents 822 may be provided in optional forms, consistencies, and states for example including but not limited to fluid, liquid, gel, gas, solid, freeze dried, plasma, the like or any combination thereof. For example, agents 822 may in fluid form, loosely packed particles, compressed granulated particles, or a mixture thereof.

Capsule housing 820 may be provided in optional forms for example including a rigid housing, a loose form packaging, flexible housing. Capsule housing 820 may be provided from any materials conducive and capable of for both storing agents 822 and to facilitate forming lather when agents 822 are exposed and/or introduced to water. For example, capsule housing 820 may be formed from any material or a combination of materials for example including but not limited to metals, metallic alloys, polymers, plastics, hard plastics, flexible materials, the like or any combination thereof.

In some embodiments capsule 804 may comprise more than one compartments, for example wherein housing 820 has at least two sub-compartments. In such a multi compartment of housing 820 each compartment may contain a different lathering agent.

In some embodiments at least one face of capsule 804 may form a filter through which the prepared lather is delivered.

In some embodiments at least one face of housing 820 may form a filter through which the prepared later is delivered.

In some embodiment a filter (not shown) may be disposed as part of capsule housing 814 to facilitate lather production.

In embodiments capsule housing 814 is in fluid communication with nozzle 816 so as to delivery lather 826 generated with device 800.

Capsule housing 814 is provided to receive capsule 804 until such a time that later is generated and delivered through nozzle 816.

In some embodiments housing 814 may provide a mixing chamber wherein contents of capsule 804 in the form of lather agents 822 may be mixed with water and/or air. In some embodiment mixing to generate lather 826 may take place within capsule housing 820. In some embodiment mixing to produce lather 826 may take place within a dedicated portion of capsule housing 814 disposed between capsule 804 and nozzle 816.

In some embodiments, water reservoir 808 may optionally be an integral unit of housing 806.

In some embodiments water reservoir 808 preferably form a separate independent housing for receiving and holding a volume of water that features a valve so as to control the flow and delivery of water from reservoir 808 into housing 806.

In embodiments water pump 810 provides for pumping water from reservoir 810 via piping toward capsule housing 814. Accordingly pump 810 provide for delivering sufficient amount of water under pressure through device 800. Preferably pump 810 is configured to be operational at a pressure of about 1-2 bar. In some embodiments pump 810 may be configured to be operate at a pressure of up to about 15 bar.

Most preferably pump 810 provides for driving water under pressure toward heating module 812 that provides for heating the required amount of water in a short period of time. For example water heating module may be configured to a power profile from about 1200 Watts and up to about 3000 Watts, more preferably heating module 812 utilizes a power profile of about 1550 Watts.

In some embodiments heating module 812 may be utilized to heat capsule 804 so as to heat the contents thereof for example lathering agents 822.

In some embodiments device 800 may optionally further feature an air compressor 828. In such embodiments air compressor 828 may provide for cleaning piping within device 800 and in particular nozzle 816. Air compressor 828 may further be utilized to delivered air under pressure into at least one of chamber 814 and/or capsule 804 so as to facilitate generation of lather 826 by way of air delivery. Most preferably control air pup 828 is provide with electronic module 824 so as to control the delivery rate, overall volume of air delivery and timing of air delivery.

In some embodiments device 800 may optionally further feature a mechanical mixing module 818. In some embodiment mixing module 818 may provide a mixing chamber and mechanical means to ensure appropriate mixing and later generation. For example, mixing module 818 may for example feature a driven impeller, agitator, mixing plate, mixing rod, the like or any combination thereof. In some embodiments mixing module 818 may be driven by optional means such as an actuator, a motor, a piezoelectric element, the like or any combination thereof. For example, a mixing module 818 may be provided in the form of mixing rod that is introduced into at least one or capsule 804 and/or capsule housing 814 so as to facilitate mixing of agents forming lather 826. Optionally mixing module 818 provided in the form of an agitator may provide for agitating capsule 804 within housing 814. Optionally mixing module 818 in the form of an impeller and/or mixing plate may be coupled to a motor or the like actuator the cause lathering agents, water, and/or air to mix as it is generated within housing 814 and/or prior to its delivery via nozzle 816. In embodiment the functioning of module 818 may be provided with electronics module 824 to at least control the rate and timing of operation to optimize generation of lather 826.

Device 800 and modules therein are rendered operational with circuity and electronics module 824 comprises a plurality of optional sub-modules for example including but not limited to a power supply sub-module, controller and/or processor sub-module, human interface sub-module, and memory sub-module. In some embodiments electronics module 824 may further comprise a communication module sub-module.

In embodiments processor sub-module provides the necessary processing hardware and/or software necessary to render device 800 functional.

In embodiments power sub-module provides the necessary hardware and/or software to power device 800 therein rendering device 800 operational.

In embodiments human interface sub-module provides the necessary processing hardware and/or software necessary to provide device 800 with the ability to interface with the user in at least one or more facets. Human interface sub-module may for example include but is not limited to at least one or more of display, buttons, input keyboard, light emitting diode displays the like or any combination thereof.

In embodiments memory sub-module provides the necessary memory capabilities both in the form of hardware and/or software necessary to render device 800 functional.

In embodiments communication sub-module provides the necessary processing hardware and/or software necessary to allow device 800 to communicate with at least one or more communication and processing device (not shown) for example in the form of a computer, server, smartphone, mobile telephone, or the like communication and processing device. In embodiments the communication sub-module may utilize any communication protocol as is known in the art for example including but not limited to wireless communication, wireless fidelity (WIFI), near field communication (NFC), RF communication, optical communication, IR communication, BLUETOOTH, the like or any combination thereof.

In some embodiments communication submodule of electronics module 824 may be in wireless communication with at least one or more communication and processing device (not shown) so as to manage and/or monitor shaving use of at least one or more of lather, blades and/or razors. In some embodiments such use monitoring may be utilized to automate purchase and/or ordering of new lather capsules 804 and/or razor blades (not shown) or the like shaving accessories or personal care items for example including but not limited to balms, creams, gels, after-shave, cologne, perfumes, facial towels the like or any combination thereof.

In some embodiments device 800 and/or system 802 may be fit with a user safety and/or counterfeit measures so as to ensure that device 800 and/or system 802 is used only with authorized and/or authentic capsules 804. Such a safety measure ensures that a user is not exposed to harmful agents and/or ingredients that may be utilized by a counterfeit lather capsule and/or lathering agent. Such safety measures may be rendered with at least one or both of electronics module 824 or capsule housing.

For example, electronics module 824 and/or capsule housing 814 may be utilized to facilitate electronic identification and/or verification of the authenticity and/or manufacturing integrity of capsule 804 wherein capsule 804 may be provided with electronic identification for example including but not limited to a readable RFID tag and/or barcode or the like identification means that may be read and/or authenticated with at least one of electronics module and/or capsule housing 814.

For example, in some embodiments capsule housing 814 may feature a mechanical identification member configured to match and/or cooperate with a matching and/or corresponding identification member provided on capsule 804 more preferably along capsule housing 820.

FIG. 9 shows a flow chart of the method for producing lather 826 with device 800 according to embodiments of the present invention.

Initially in stage 900 a capsule 804 is loaded and/or received into device 800 within capsule housing 814. Most preferably, the user may determine the type of capsule to utilize wherein an individual capsule may be provided in different fragrances, properties, consistencies as selected by the user. User initiates formation of lather 826 with a user interface control button as part of electronics module 824.

Next in stage 902, pump 810 draws and/or pumps water/liquid from reservoir 808 via a valve (not shown) and causing water/liquid to flow through piping within housing 806. Water/liquid from reservoir 808 is ultimately pumped with pump 810 from reservoir 808 toward capsule housing 814.

Next in stage 904 as water/liquid is pumped it is heated with heating module 812 so as to heat the water/liquid to a controllable temperature.

Next in stage 906, electronic module 824 preferably controls the volume of water/liquid heated, the temperature heating range, the water pressure applied within housing 806 to ensure that the appropriate water/liquid parameters are provided by device 800. Preferably, pump 810 and heater 812 are controlled with electronics module 824 to ensure correct function with respect to the user and/or the type of lather agents 822 and/or capsule 804 selected by the user.

Next in stage 908, the appropriate volume of water/liquid at the correct temperature and pressure is introduced into capsule housing 814; this is to allow mixing of lathering agent(s) 822 and water/liquid to react with one another so as to form the lather 826. In some embodiment mixing may take place within a dedicated portion of capsule housing 814 or directly within capsule 804. Optionally the water/liquid pressure may be controlled by the diameter of the piping utilized at and/or adjacent to housing 814 or capsule 804.

In a first optional stage 910, an optional mixing module 818 may be employed in order to properly mix the lather so as to ensure that lathering agent(s) 822 has properly mixed with the water/liquid to form the lather 826.

In an additional optional stage 912, optional air compressor 828 may be used to introduce compressed air into capsule housing 814 and/or capsule 804 so as to enrich the mixture with air so as to form a water/liquid, lathering agent and air mixture forming an air enriched lather 826.

Optionally both stages 910 and 912 may be employed in any order and/or combination with the preceding stages.

Next in stage 914 the prepared lather is delivered through nozzle 816. In some embodiments lather 826 may be delivered with the use of air pump 828. In some embodiments lather 826 may be delivered with the use of water/liquid pump 810.

Next in an optional final stage device 800 may be cleaned from any remaining debris and/or remnants of lathering agents within the piping of device 800, stage 916. Preferably such a cleaning phase may be accomplished by employing a self-clean stage wherein either air under pressure, provided with air compressor 828, and/or water under pressure, provided with water/liquid pump 810, are flown through piping to clean device 800.

In some embodiments a further optional stage may be utilized to monitor use of system 802 and/or device 800 by undertaking communication with an auxiliary communication and processing device, a previously described, preferably via a communications submodule of electronics module 824.

Preferably such communication provides for managing and/or monitoring shaving use of at least one or more consumer products associated with shaving for example including but not limited to shaving cream, lather, shaving cartridges, blades and/or razors, or the like. In some embodiments such use monitoring may be utilized to automate purchase and/or ordering of shaving associated consumable produces and/or accessories such as lather capsules 804, razor blades (not shown), shaving accessories, personal care items, balms, creams, gels, after-shave, cologne, perfumes, facial towels, razor cartridges the like or any combination thereof.

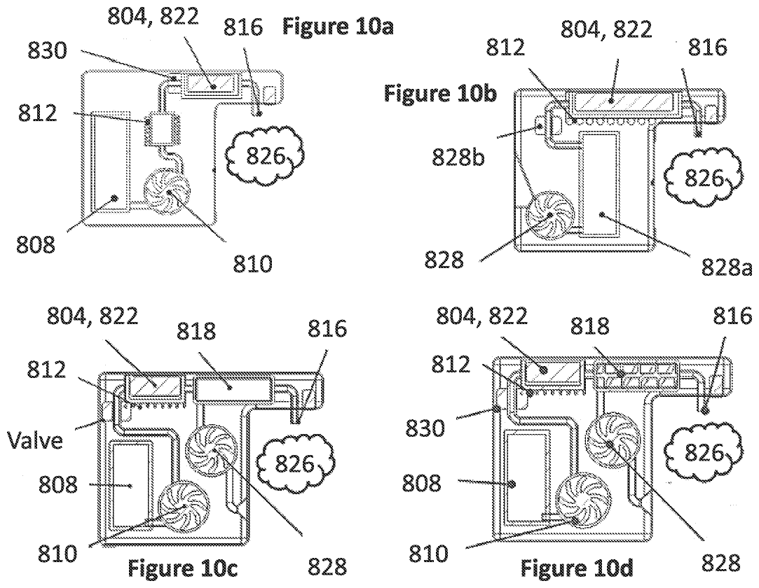

FIG. 10A-D show optional configurations of system 802 according to embodiments of the present invention.

FIG. 10A shows system 802 implemented in a similar fashion as that depicted in FIG. 1, wherein capsule 804 is provided in the form of a dry capsule wherein agents 822 are in dry form wherein heated water/liquid is added to generate a lather 826. An optional filter 830 is also employed to filter water prior to mixing with capsule 804.

FIG. 10B shows system 802 wherein device 800 utilizes a capsule 804 having liquid and/or wet lathering agents 822, therefore device 800 is devoid of a water/liquid reservoir 808 and water pump 810. In this embodiment device 800 comprises an air compressor assembly 828 that includes an air tank and/or reservoir 828a that is further fit with a corresponding valve 828b in order to control the flow. As previously describe compressor assembly 828 may be used in this manner to introduce air and to control the air pressure utilized to form lather 826. In some embodiments compressor assembly may be utilized with other form of gasses for example including but not limited to carbon dioxide (CO2) that may be under pressure.

FIG. 10C-10D shows system 802 that further comprises mixing module 818. FIG. 10C shows mixing module 818 in the form of a mixing chamber that is coupled to an air compressor 828. FIG. 10D shows module 818 wherein mixing chamber is further fit with a mechanical agitator to ensure proper mixing and lathering.

### Exemplary Embodiments of Devices

Referring now to FIG. 11 showing a schematic representation of an exemplary lather generating and dispensing device 1100, according to some embodiments of the present invention.

In some embodiments, the device comprises a body 1102, a lather container 1104 configure to receive the lather that is generated, an orifice 1106 to insert a capsule 1108 (in this case the capsule comprises a tube configuration), a water source compartment 1110 and a control panel 1112 configured to allow the user to choose the operational settings of the device.

In some embodiments, the device 1100 is activated by an internal energy source (batteries/rechargeable batteries). In some embodiments, the device 1100 is activated by an external energy source (plugged into the electricity). Optionally, the device's energy source is both internal and external energy sources. In some embodiments, the device 1100 water source/liquid source is an internal source, meaning the user inserts water/liquid into the water/liquid source compartment and the device utilizes the water/liquid that is kept in the compartment. In some embodiments, the device 1100 water source/liquid source is an external source, meaning the device is connected to an external water/liquid source. Optionally, the device's water/liquid source are both internal and external water/liquid sources.

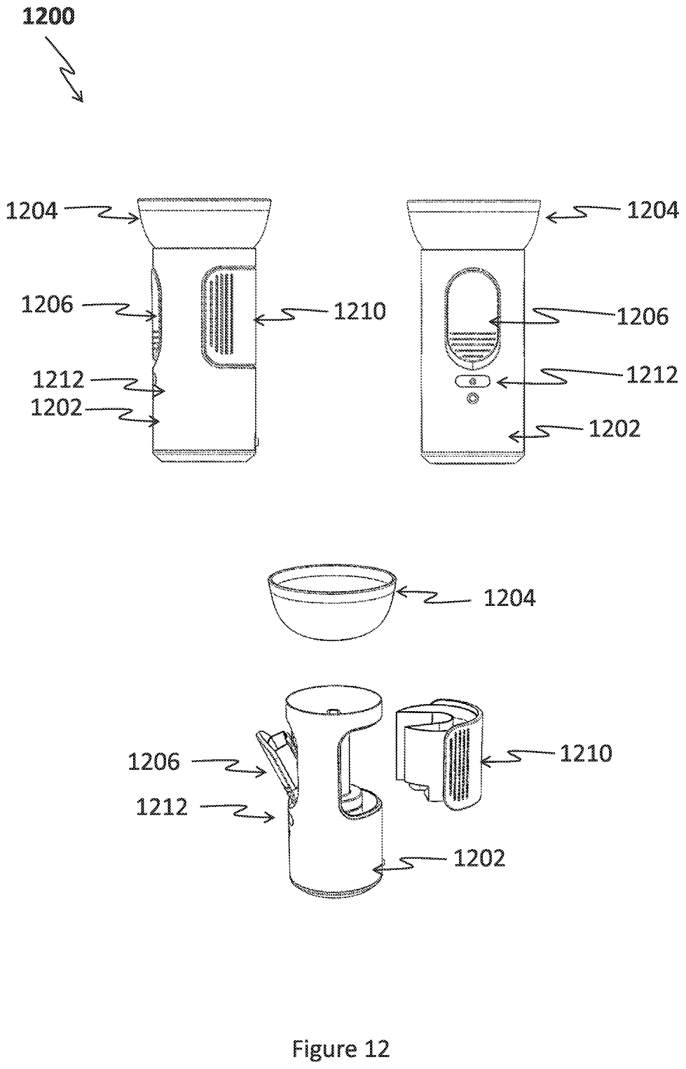

Referring now to FIG. 12 showing a schematic representation of another exemplary lather generating and dispensing device 1200, according to some embodiments of the present invention.

In some embodiments, the device comprises a body 1202, a lather container 1204 configure to receive the lather that is generated, a capsule compartment 1206 to insert a capsule (not shown—in this case the compartment is configured to allow a capsule having a rectangular configuration), a water/liquid source compartment 1210 and a control panel 1212 configured to allow the user to choose the operational settings of the device.

In some embodiments, the device 1200 is activated by an internal energy source (batteries/rechargeable batteries). In some embodiments, the device 1200 is activated by an external energy source (plugged into the electricity). Optionally, the device's energy source is both internal and external energy sources. In some embodiments, the device 1200 water/liquid source is an internal water/liquid source, meaning the user inserts water/liquid into the water/liquid source compartment and the device utilizes the water/liquid that is kept in the compartment. In some embodiments, the device 1200 water/liquid source is an external water/liquid source, meaning the device is connected to an external water/liquid source. Optionally, the device's water/liquid source are both internal and external water/liquid sources.

Referring now to FIG. 13 showing a schematic representation of another exemplary lather generating and dispensing device 1300, according to some embodiments of the present invention.

In some embodiments, the device comprises a body 1302, a lather container 1304 configured to receive the lather that is generated, a capsule compartment 1306 to insert a capsule 1308. In this embodiment, the capsule compartment 1306 includes the mixing mechanism 1314. In this embodiment, the capsule 1308 is configured as dome-like capsule. In some embodiments, the area under the dome-like structure is configured to receive the mixing mechanism 1314. The device 1300 comprises a water/liquid source compartment (not shown) and/or the device is connected to an external water/liquid source and/or the capsule 1308 itself comprises the necessary water/liquid, as disclosed above. The device 1300 comprises a control panel 1312 configured to allow the user to choose the operational settings of the device.

In some embodiments, the device 1300 is activated by an internal energy source (batteries/rechargeable batteries). In some embodiments, the device 1300 is activated by an external energy source (plugged into the electricity). Optionally, the device's energy source is both internal and external energy sources.

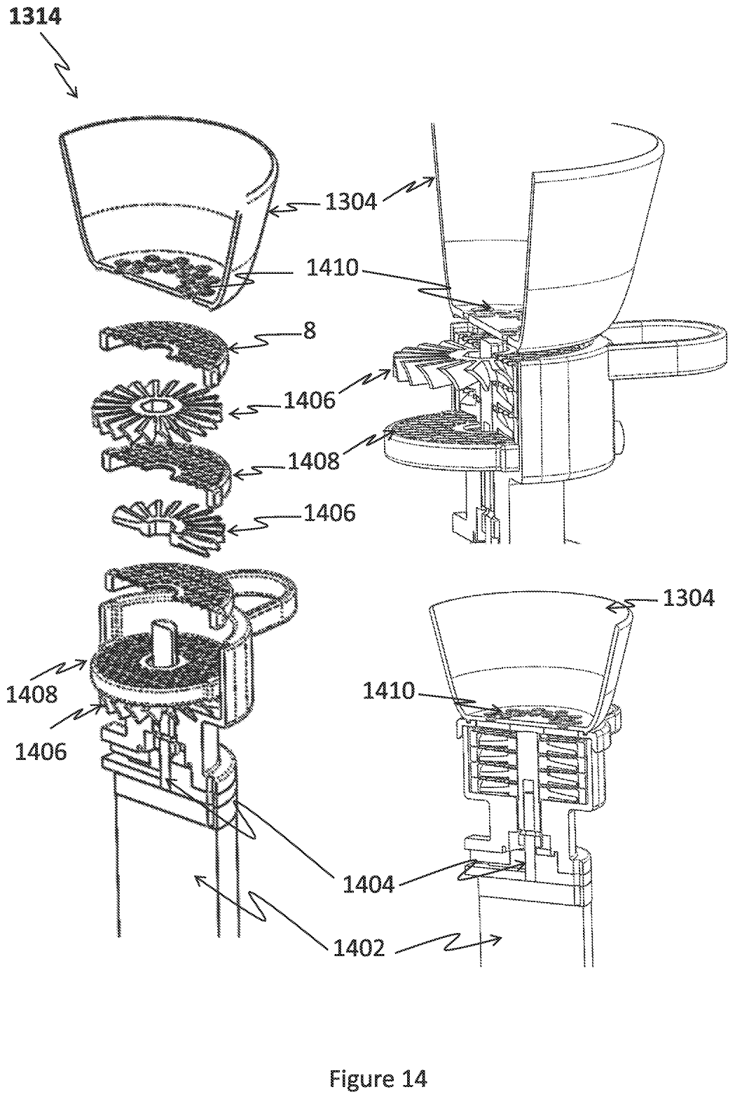

Referring now to FIG. 14 showing a schematic representation of a mixing mechanism 1314, according to some embodiments of the present invention. In some embodiments, the mixing mechanism 1314 for example of the device 1300 disclosed in FIG. 13, comprises a motor 1402 connected to a pivot 1404, which is connected and rotates at least one rotor (in this case in the form of an impeller) 1406. The impeller is coupled with at least one net 1408 which does not move. In some embodiments, the device comprises a plurality of sets of impeller/net in the mixing mechanism, as shown for example in FIG. 14. In some embodiments, the plurality of impellers rotates at the same direction. In some embodiments, the plurality of impellers rotates at different directions. In some embodiments, the rotation of the impeller in the net provides the physical force required for the production of the lather. In some embodiments, the rotation of the impeller in the net provides the shear between surfaces at high speeds necessary for the generation of lather. In some embodiments, the capsule 1308 is inserted in the device 1300 and the mixing mechanism 1314 comprising the plurality of impellers 1406 and nets 1408 are located inside the area below the capsule 1308, as shown for example, in FIG. 13. In some embodiments, the impellers are disposable impellers that are changed by the user periodically.

In some embodiments, the velocity of the mixing mechanism is from about 10 RPM to about 1000 RPM. Optionally from about 100 RPM to abut 700 RMP. Optionally from about 300 RPM to abut 500 RMP. For example 50 RPM, 150 RMP, 400 RPM.

In some embodiments, the lather container 1304 (receptacle) comprises a plurality of holes 1410 at the bottom. In some embodiments, during the production of lather, the already made lather enters through the holes 1410 at the bottom of the lather container 1304. In some embodiments, since the consistency of the lather is thick, the already made lather cannot return down through the holes 1410 towards the mixing mechanism 1314.

In some embodiments, the device 1300 comprises a heating mechanism (not shown). In some embodiments, the heating mechanism heats the capsule compartment. In some embodiments, the heating mechanism heats the bottom of the cup.

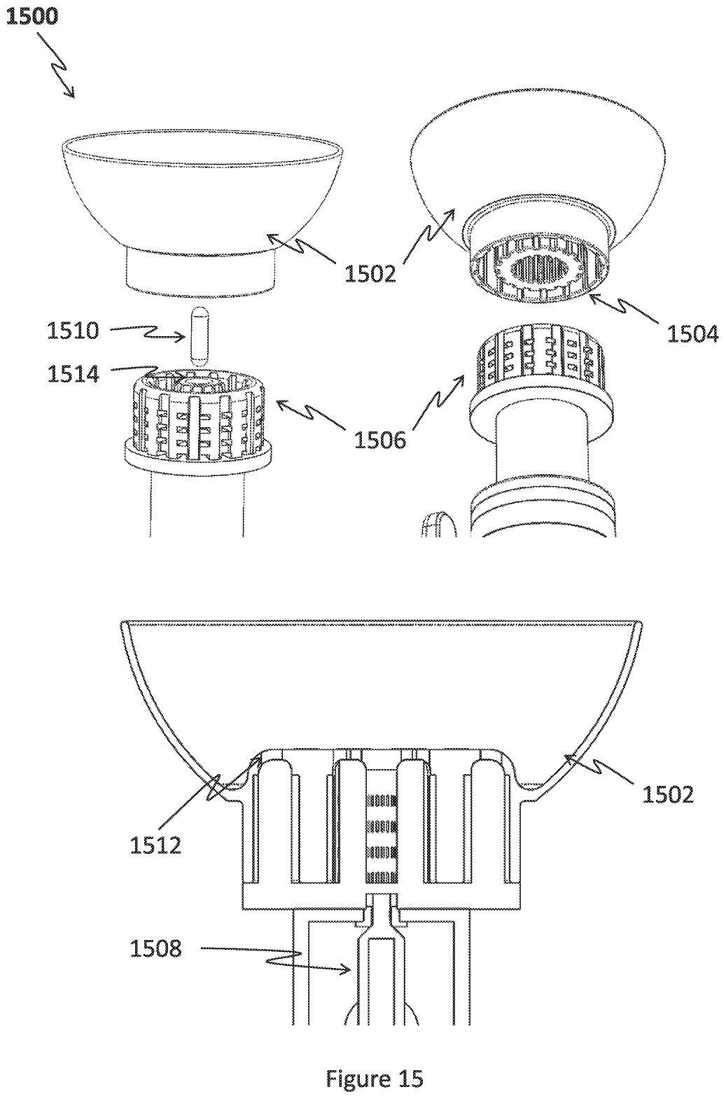

Referring now to FIG. 15 showing a schematic representation of another mixing mechanism 1500 located inside the body (not shown) of the device, according to some embodiments of the present invention.

In some embodiments, the mixing mechanism 1500 is based on a centrifugal mechanism. In some embodiments, the lather container 1502 comprises a locking mechanism 1504 configured to enable the reversible attachment of the lather container to the body. In some embodiments, the mixing mechanism comprises a rotor in the form of a rotating body 1506 comprising holes, the rotating body is connected to a pivot 1508, which is connected to a motor (not shown). In this embodiment, the capsule 1510 comprising the raw lather materials, comprises a form of a pill. In some embodiments, the capsule can have any other form, as disclosed herein. In some embodiments, the capsule 1510 is inserted in to the capsule compartment 1514 where it dissolves at the contact with water from the water supply. In some embodiments, the water from the water source (not shown) dissolves the capsule 1510 and the rotation of the rotating body 1506 creates the lather final product, which is then expelled through holes 1512 into the lather container 1502. In some embodiments, the rotation of the rotating body provides the shear between surfaces at high speeds necessary for the generation of lather.

In some embodiments, the rotating mechanism is disposable and is changed by the user periodically.

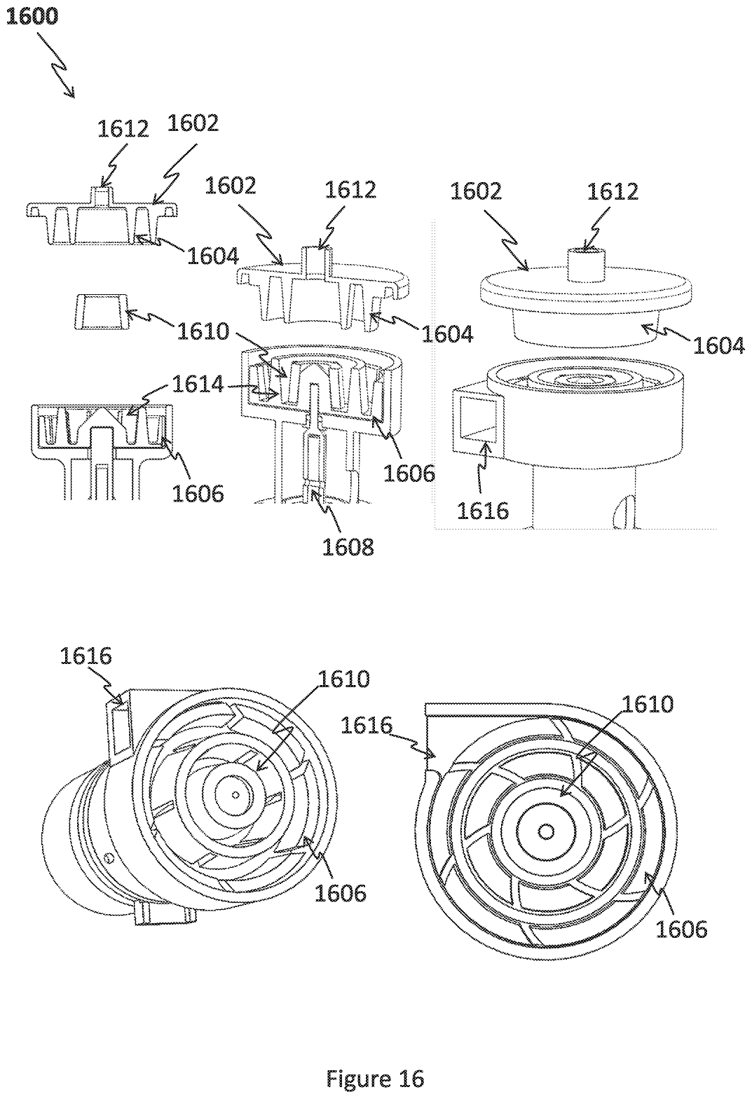

Referring now to FIG. 16 showing a schematic representation of another centrifugal mixing mechanism 1600 located inside the body (not shown) of the device, according to some embodiments of the present invention.

In some embodiments, the lather container 1602 comprises a locking mechanism 1604 configured to enable the reversible attachment of the lather container to the body, in this figure only the bottom of the lather container is shown. In some embodiments, the mixing mechanism comprises at least one rotating body 1606 comprising apertures, the rotating body (or bodies) is connected to a pivot 1608, which is connected to a motor (not shown). In some embodiments, the rotation of the rotating body provides the shear between surfaces at high speeds necessary for the generation of lather. In this embodiment, the capsule 1610 comprising the raw lather materials, comprises a form of a dome-like capsule. In some embodiments, the capsule can have any other form, as disclosed herein. In some embodiments, the capsule 1610 is inserted in to the capsule compartment 1614 where it dissolves at the contact with water from the water supply. In some embodiments, the water from the water source (not shown) dissolves the capsule 1610 and the rotation of the rotating body 1606 creates the lather final product, which is then expelled through a single hole 1612 into the lather container 1602. In some embodiments, the device optionally comprises and entry 1616 for the water source. In some embodiments, the water source is located inside the capsule 1610.

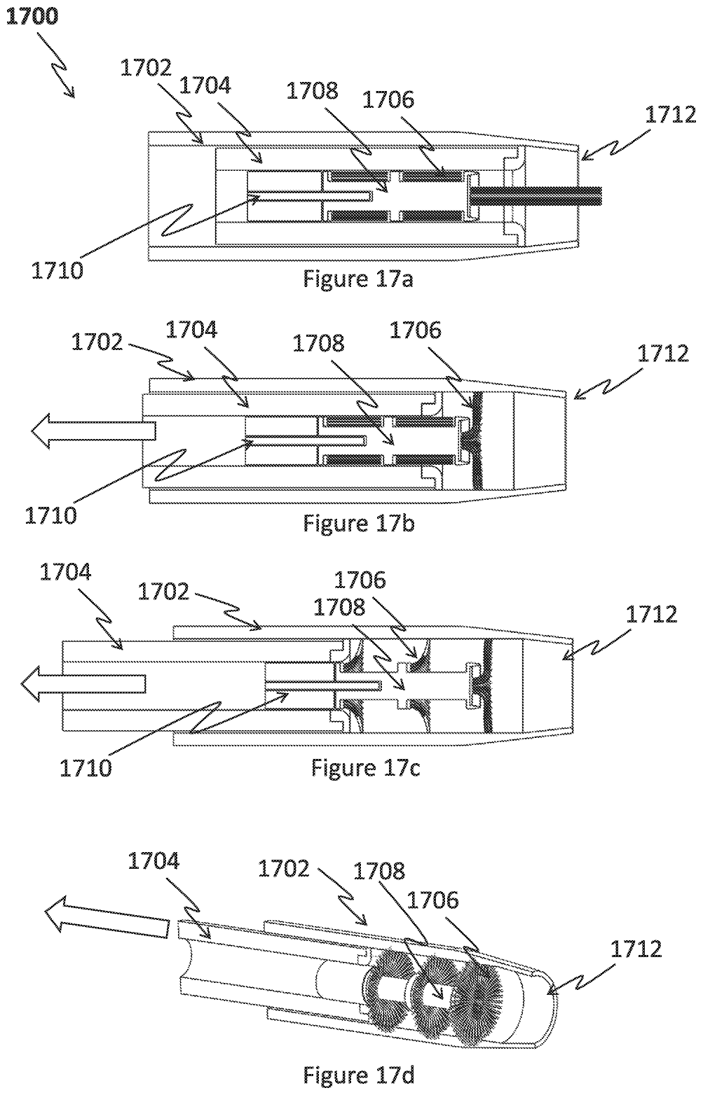

Referring now to FIGS. 17a-d, showing a schematic representation of another mixing mechanism 1700 located inside the body 1702, according to some embodiments of the present invention.

In some embodiments, the mixing mechanism comprises a cover body 1704 configured to move forwards and backwards inside the body 1702 of the device. In some embodiments, the mechanism further comprises a plurality of brushes 1706 allocated on a central stand 1708, which is connected to a pivot/rotor 1710 that is connected to a motor (not shown). In some embodiments, the cover body 1704 moves backwards (following the arrow) exposing the plurality of brushes 1706. In some embodiments, rotation of the plurality of brushes creates the lather that then exits the device from the exit at the front 1712. FIG. 17a shows the device where the cover body 1704 is completely forward covering all the brushes and the first brush is folded towards the front. FIG. 17b shows the beginning of the movement backwards of the cover body 1704 and the first brush is open. FIG. 17c the cover body 1704 is completely backwards and all the brushes are exposed. FIG. 17d is a perspective view of FIG. 17c.

In some embodiments, the brushes are disposable brushes that are changed by the user periodically.

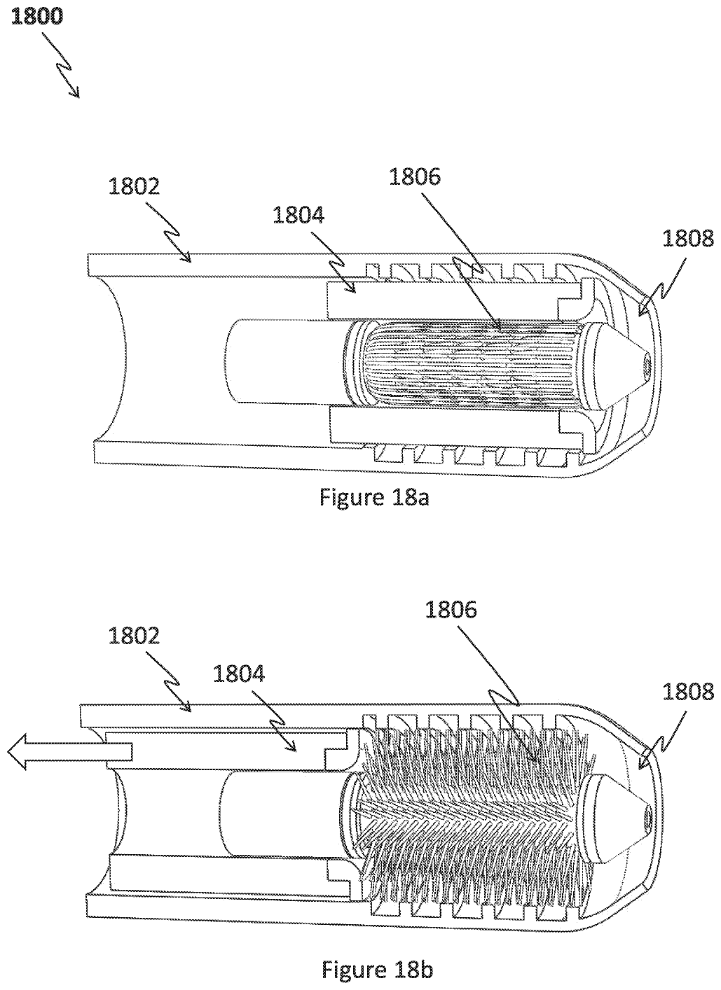

Referring now to FIGS. 18a-b, showing schematic representations of another brushes-based mixing mechanism 1800 located inside the body 1802, according to some embodiments of the present invention.

In some embodiments, the mixing mechanism comprises a cover body 1804 configured to move forwards and backwards inside the body 1802 of the device. In some embodiments, the mechanism further comprises a single big brush 1806 allocated on a central stand (not shown), which is connected to a pivot (not shown) that is connected to a motor (not shown). In some embodiments, the cover body 1804 moves backwards (following the arrow) exposing the brush 1806. In some embodiments, rotation of the brush creates the lather that then exits the device from the exit at the front 1808. FIG. 18a shows the device where the cover body 1804 is completely forward covering the brush. In FIG. 18b the cover body 1804 is completely backwards and the brush is exposed.

### Exemplary Head Configurations

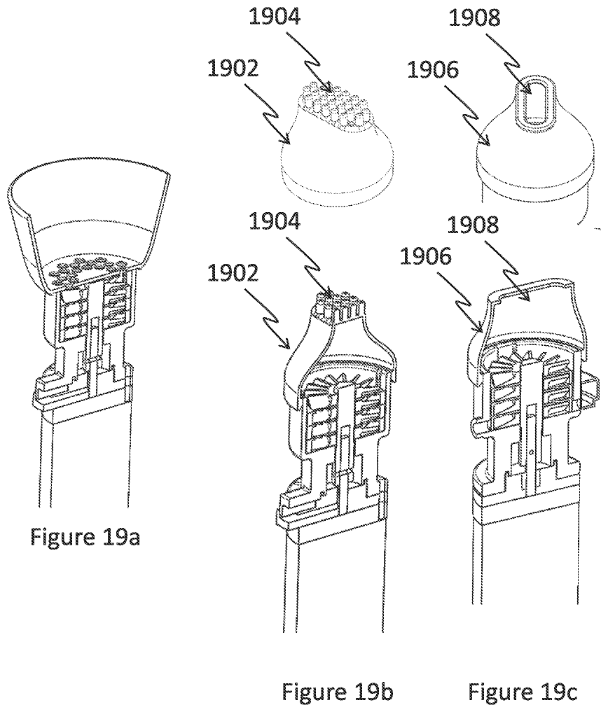

In some embodiments, the lather created is pushed and/or ejected into a lather container, as disclosed above. In some embodiments, the lather container can be exchanges with dedicated head applicators, as shown for example in FIGS. 19a-c.

Referring now to FIGS. 19a-c showing schematic representations of head applicators, according to some embodiments of the present invention. FIG. 19a shows an embodiment of a device as previously explained. The device comprises a cup with orifices, and the lather that is generated is ejected into the cup. FIG. 19b shows an embodiment where, instead of the cup, there is a head applicator 1902 comprising soft protrusions 1904. Inside each soft protrusion there is a hole where the generated lather exits. In some embodiments, the user applies the lather directly to the place using the soft protrusions as a brush. FIG. 19c shows an embodiment where, instead of the cup, there is a head applicator 1906 comprising a large opening 1908 where the generated lather exits. In some embodiments, the user may apply the lather directly to the place or onto his hand.

In some embodiments, the heads are disposable heads that are changed by the user periodically.

### Exemplary Capsule Configurations

Referring now to FIGS. 20a-h, showing schematic representations of different embodiments of capsules, according to some embodiments of the present invention.

In some embodiments, the capsules contain raw lather material that, once in contact with water and physical agitation, allow the creation of lather. In some embodiments, the capsules contain only the lather raw material. In some embodiments, the capsules a plurality of materials other than lather raw material, for example, aftershave, softener, perfume, medicaments, the water source and others.

In some embodiments, the capsule comprises a plurality of compartments, each containing at least one material. In some embodiments, the materials can be solid or liquid. In some embodiments, each capsule may comprise a mix of materials, one solid and one liquid. Optionally both liquid. Optionally both solid.

Referring now to FIG. 20a showing a schematic representation of a capsule having a dome like configuration 2002. In some embodiments, the capsule is made of dissolvable materials. In some embodiments, once the outer material is dissolved the inner materials are released and then mixed to create the lather. In some embodiments, the dome-like capsule is configured to be mounted on the mixing mechanism. In some embodiments, the capsule is ring-like 2004, as sown for example if FIG. 20b. In some embodiments, the capsule comprises a tablet configuration, as shown for example in FIG. 20c. In some embodiments, the tablet configuration comprises multiple materials, some on the outside 2006 and some on the inside 2008. In some embodiments, the capsule comprises an irregular form, like a triangle, as shown in FIG. 20d. In some embodiments, also in this triangle configuration, multiple materials are used in the capsule (2010, 2012). In some embodiments, the internal configuration of the capsule is complex, as shown for example in FIG. 20e. In some embodiments, the internal configuration comprises a plurality of compartments, optionally, each compartment may comprise a different material.

In some embodiments, capsules can be acquired as kits comprising a plurality of capsules each, as shown for example in FIGS. 20f and 20g. FIG. 20f shows a plurality of triple-material (2014, 2016 and 2018) capsules and the package 2020 where the capsules are contained. FIG. 20g shows a plurality of disk-like capsules having a hexagon configuration, stocked on each other 2022 and the package where they are contained 2024.

In some embodiments, dedicated kits containing capsules 2028 and shaving knives 2030 are available, as shown for example in FIG. 20h.

While the invention has been described with respect to a limited number of embodiment, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not described to limit the invention to the exact construction and operation shown and described and accordingly, all suitable modifications and equivalents may be resorted to, falling within the scope of the invention.

It should be noted that where reference numerals appear in the claims, such numerals are included solely or the purpose of improving the intelligibility of the claims and are no way limiting on the scope of the claims.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

While the invention has been described with respect to a limited number of embodiments, it will be appreciated that many variations, modifications and other applications of the invention may be made.

It is expected that during the life of a patent maturing from this application many relevant lather-mixing machines will be developed; the scope of the terms is intended to include all such new technologies a priori. As used herein with reference to quantity or value, the term “about” means “within ±25% of”. The terms “comprises”, “comprising”, “includes”, “including”, “has”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure. As used herein, the singular forms “a”, “an” and “the” include plural references unless the context clearly dictates otherwise. For example, the term “a compound” or “at least one compound” may include a plurality of compounds, including mixtures thereof.

Throughout this application, embodiments of this invention may be presented with reference to a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as “from 1 to 6” should be considered to have specifically disclosed subranges such as “from 1 to 3”, “from 1 to 4”, “from 1 to 5”, “from 2 to 4”, “from 2 to 6”, “from 3 to 6”, etc.; as well as individual numbers within that range, for example, 1, 2, 3, 4, 5, and 6. This applies regardless of the breadth of the range. Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween. Unless otherwise indicated, numbers used herein and any number ranges based thereon are approximations within the accuracy of reasonable measurement and rounding errors as understood by persons skilled in the art.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements. Various embodiments and aspects of the present invention as delineated hereinabove and as claimed in the claims section below find support in the following examples.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

In addition, any priority document(s) of this application is/are hereby incorporated herein by reference in its/their entirety.

In the claims:

1. A device for generating lather comprising:
a. a capsule compartment sized and shaped to receive at least one capsule;
b. a liquid source fluidly connected to said capsule compartment to provide at least one liquid to said compartment;
c. a lather generating cell that generates lather from at least one lather-generating raw material and said at least one liquid;
d. a receptacle positioned and fluidly coupled to receive said generated lather; and
e. a temperature modulator positioned to modify a temperature of at least a part of said device and thereby modifying a temperature of said generated lather.

2. The device according to claim 1, wherein said capsule compartment acts as said lather generating cell.

3-4. (canceled)

5. The device according to claim 1, wherein said lather generating cell comprises at least one rotor, which rotates to generate said lather.

6. The device according to claim 5, wherein said at least one rotor is in the form of one or more of an impeller; a brush; a centrifugal component and/or any combination thereof.

7-8. (canceled)

9. The device according to claim 1, further comprising at least one of said capsule.

10. The device according to claim 1, wherein said capsule comprises multiple compartments; and wherein each compartment of said multiple compartments contain a different material.

11. The device according to claim 10, wherein said different material is selected from the group consisting of at least one lather-generating raw material, aftershave, softener, perfume, medicaments, said at least one liquid, water and any combination thereof.

12. The device according to claim 1, wherein said liquid source is located in said capsule.

13. (canceled)

14. The device according to claim 1, wherein said receptacle is located at a top-most part of said device.

15. The device according to claim 1, wherein said device further comprises a controller, said controller comprises a timer that finishes a cycle of generating lather in 30 seconds or less.

16. (canceled).

17. The device according to claim 15, wherein said controller comprises a communications module configured to communicate with at least one external device.

18. The device according to claim 1, wherein said lather generating cell is sized and shaped to include said rotor and space for at least 20% of the lather that is being generated.

19-22. (canceled)

23. The device according to claim 1, wherein said device is waterproof.

24. The device according to claim 1, wherein said lather generating cell includes said capsule compartment.

25. The device according to claim 1, wherein said temperature modulator modulates temperatures from about 4 degrees Celsius to about 40 degrees Celsius.

26-30. (canceled)

31. A method of generating lather in a lather generating device, comprising:
a. receiving at least one capsule comprising at least one lather-generating raw material into a capsule compartment;
b. receiving at least one liquid from at least one liquid source;
c. generating lather in a lather generating cell by mixing said at least one lather-generating raw material and said at least one liquid;
d. moving said generated lather into a receptacle;
wherein said method comprises modifying a temperature of one or more of said liquid; said lather generating cell; said receptacle; and any combination thereof.

32. The method according to claim 31, wherein said generating comprises generating in said capsule compartment.

33. (canceled)

34. The method according to claim 31, wherein said modifying comprises heating or cooling at least one selected from the group consisting of: said liquid; said lather generating cell; said receptacle; and any combination thereof.

35. (canceled)

36. The method according to claim 31, wherein said generating comprises forming said lather by rotating a rotor in said generating cell.

37. (canceled)

38. The method according to claim 36, wherein said rotating comprises rotating in a center of said cell, in a periphery of said cell and/or a combination of both.

39-49. (canceled)
